(19) United States
(12) Patent Application Publication
(10) Pub. No.: US 2024/0427583 A1
(43) Pub. Date: Dec. 26, 2024

(54) DISPLAY APPARATUS AND PROCESSING METHOD FOR DISPLAY APPARATUS

(71) Applicant: HISENSE VISUAL TECHNOLOGY CO., LTD., Qingdao (CN)

(72) Inventors: Xiaoming SHAO, Qingdao (CN); Guohui ZHU, Qingdao (CN); Bingqi LU, Qingdao (CN)

(21) Appl. No.: 18/824,796

(22) Filed: Sep. 4, 2024

Related U.S. Application Data
(63) Continuation of application No. PCT/CN2023/084851, filed on Mar. 29, 2023.

(30) Foreign Application Priority Data
Apr. 1, 2022 (CN) 202210347140.0
May 23, 2022 (CN) 202210561383.4

(51) Int. Cl. G06F 8/61; H04N 21/81

(52) U.S. Cl. CPC G06F 8/61; H04N 21/8173

(57) ABSTRACT

Provided are a display apparatus and a processing method for the display apparatus. The display apparatus includes a display; a communicating device; and a user port for receiving an input signal, at least one processor connected with the display and the user port and configured to: detect a current state of the display apparatus when receiving a first instruction comprising a specific key value; perform an operation corresponding to the first instruction according to the current state; while the display apparatus is in a first standby state, the processor is configured to: power on the display, determine whether a target application corresponding to the specific key value has been installed, control the display to display query information if the target application has not been installed, determine whether the target application is running in foreground if the target application has been installed.

### CROSS-REFERENCES TO RELATED APPLICATIONS

This disclosure is a continuation application of PCT Application No. PCT/CN2023/084851, filed on Mar. 29, 2023, which claims priorities to Chinese Patent Application No. 202210347140.0 filed to the China National Intellectual Property Administration on Apr. 1, 2022, and Chinese Patent Application No. 202210561383.4 filed to the China National Intellectual Property Administration on May 23, 2022, all of which are hereby incorporated by reference in their entirety.

### TECHNICAL FIELD

The disclosure relates to the technical field of intelligent display apparatuses, and in particular, to a display apparatus and a processing method for a display apparatus.

### BACKGROUND

A display apparatus refers to a terminal device that can output a specific display image, which can be a smart TV, a mobile terminal, a smart advertising screen, a projector and other terminal devices. Taking smart TV as an example, Smart TV is a TV product based on Internet application technology, with an open operating systems and chips and an open application platform, which can realize two-way human-computer interaction functions, and integrate multiple functions such as audio-visual, entertainment, and data, and is used to meet the diversified and personalized needs of users.

The application installed on the display apparatus for playing audio and video data can be called an application player. Usually, the raw picture quality (such as definition, etc.) of the audio and video data provided by different application players varies. When the display apparatus plays audio and video data provided by various application players, the playing effect of the audio and video data will be affected by the raw picture quality and the playing parameters used by the display apparatus. Therefore, the display apparatus plays the audio and video data provided by the application player, the playing effect can be effectively improved only by using playing parameters that match the audio and video data. However, since the display apparatus uses the same playing parameters when playing the audio and video data provided by various application players, the playing parameters will be difficult to match with the audio and video data provided by each application player, resulting in poor playing effect of some of the audio and video data.

### SUMMARY

Some embodiments of the disclosure provide a display apparatus. The display apparatus can include: a display and a processor. The display is configured to display images from a broadcast system and a network, and/or a user interface. The processor is configured to: receive a playing instruction from a user through a first application player; in response to the playing instruction, obtain a first virtual channel corresponding to the first application player, where different application players in the display apparatus correspond to different virtual channels, and each virtual channel is provided with independent playing parameters; obtain playing parameters corresponding to the first virtual channel; and play audio and video data provided by the first application player by using the playing parameters corresponding to the first virtual channel.

Some embodiments of the disclosure further provide a processing method for a display apparatus. The method can include: receiving a playing instruction from a user through a first application player; in response to the playing instruction, obtaining a first virtual channel corresponding to the first application player, where different application players in the display apparatus correspond to different virtual channels, and each virtual channel is provided with independent playing parameters; obtaining playing parameters corresponding to the first virtual channel; playing the audio and video data provided by the first application player by using the playing parameters corresponding to the first virtual channel.

### BRIEF DESCRIPTION OF FIGURES

FIG. 1 is a use scenario of a display apparatus in some embodiments of the disclosure.

FIG. 2 is a block diagram of a configuration of a control device in some embodiments of the disclosure.

FIG. 3 is a block diagram of a configuration of a display apparatus in some embodiments of the disclosure.

FIG. 4 is a configuration diagram of an operating system of a display apparatus in some embodiments of the disclosure.

FIG. 5 shows playing effect when a display apparatus uses playing parameters that match an application player in some embodiments of the disclosure.

FIG. 6 shows playing effect when a display apparatus uses playing parameters that do not match an application player in some embodiments of the disclosure.

FIG. 7 shows playing effect when a display apparatus uses playing parameters that match an application player in some embodiments of the disclosure.

FIG. 8 shows playing effect when a display apparatus uses playing parameters that do not match an application player in some embodiments of the disclosure.

FIG. 9 is a schematic flowchart of a processing method for a display apparatus in some embodiments of the disclosure.

FIG. 10 is a schematic diagram of a correspondence between application players and virtual channels in some embodiments of the disclosure.

FIG. 11 is a schematic diagram of a correspondence between application players and virtual channels in some embodiments of the disclosure.

FIG. 12 is a schematic flowchart of determining a virtual channel corresponding to a first application player in some embodiments of the disclosure.

FIG. 13 is a schematic flowchart of obtaining playing parameters corresponding to a first virtual channel in some embodiments of the disclosure.

FIG. 14 is a schematic diagram of a playing parameter configuration menu in some embodiments of the disclosure.

FIG. 15 is a schematic diagram of a playing parameter configuration menu in some embodiments of the disclosure.

FIG. 16 is a schematic diagram of prompt information in some embodiments of the disclosure.

FIG. 17 is a schematic flowchart of obtaining playing parameters corresponding to a first virtual channel in some embodiments of the disclosure.

FIG. 18 is a schematic flowchart of obtaining the playing parameters corresponding to a target virtual channel in some embodiments of the disclosure.

FIG. 19 is a schematic diagram of a playing parameter configuration menu in some embodiments of the disclosure.

FIG. 20 is a schematic diagram of a playing parameter configuration menu in some embodiments of the disclosure.

FIG. 21 is a schematic flowchart of adjusting playing parameters in some embodiments of the disclosure.

FIG. 22 is a schematic flowchart of displaying a playing parameter configuration menu in some embodiments of the disclosure.

FIG. 23 is a schematic diagram of a playing parameter configuration menu after adjusting the playing parameters in some embodiments of the disclosure.

FIG. 24 is a first flowchart of application launching steps in some embodiments of the disclosure.

FIG. 25 is a schematic diagram of a control device in some embodiments of the disclosure.

FIG. 26 is a first schematic diagram of a user interface in some embodiments of the disclosure.

FIG. 27 is a second schematic diagram of a user interface in some embodiments of the disclosure.

FIG. 28 is a third schematic diagram of a user interface in some embodiments of the disclosure.

FIG. 29 is a fourth schematic diagram of a user interface in some embodiments of the disclosure.

FIG. 30 is a second flowchart of application launching steps in some embodiments of the disclosure.

FIG. 31 is a schematic diagram of a historical launched application list in some embodiments of the disclosure.

FIG. 32 is a fifth schematic diagram of a user interface in some embodiments of the disclosure.

### DETAILED DESCRIPTION

Embodiments will be described in detail below, examples of which are illustrated in the drawings. When the following description refers to the drawings, the same numbers in different drawings refer to the same or similar elements, unless otherwise indicated. The implementations described in the following embodiments do not represent all implementations that are consistent with the disclosure. They are merely examples of systems and methods that are consistent with some aspects of the disclosure as detailed in the claims.

It should be noted that the brief description of terms in this disclosure is only for the convenience of understanding the embodiments described below, and is not intended to limit the embodiments of the disclosure. Unless otherwise stated, these terms should be understood according to their ordinary and usual meaning.

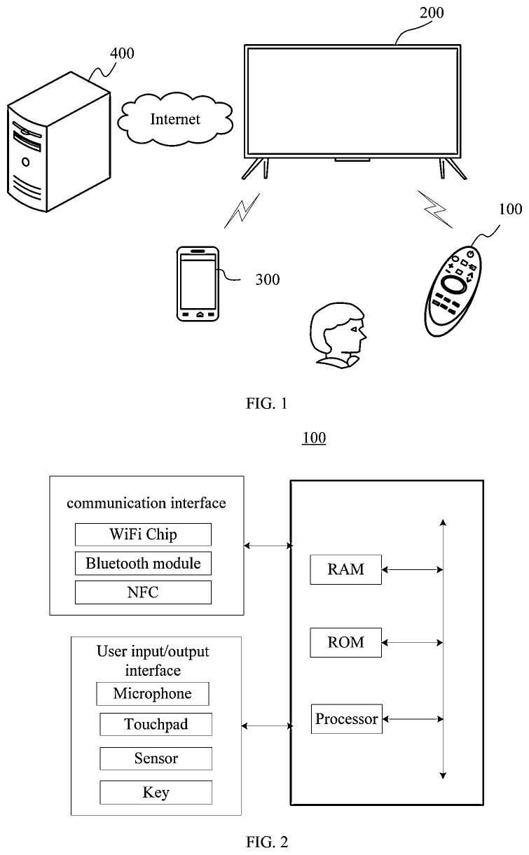

The display apparatus provided by the embodiments of the disclosure may have a variety of implementation forms, for example, it may be a smart TV, a laser projection device, a monitor, an electronic bulletin board, an electronic table, etc., or it may be a device having a display screen, such as a mobile phone, a tablet computer, and a smart watch. FIGS. 1-2 illustrate a specific implementation of the display apparatus of the disclosure.

FIG. 1 is a schematic diagram of an operation scenario between a display apparatus and a control device according to the embodiments. As shown in FIG. 1, a user can operate the display apparatus 200 through a smart device 300 or a control device 100.

In some embodiments of the disclosure, the control device 100 may be a remote controller, and the communication between the remote controller and the display apparatus can include at least one of infrared protocol communication, Bluetooth protocol communication, and other short-distance communication methods. The display apparatus 200 is controlled in a wireless or wired manner. The user may input a user command through a key, a voice input, a control panel input, etc. on the remote controller, to control the display apparatus 200.

In some embodiments of the disclosure, a smart device 300 (such as a mobile terminal, a tablet computer, a computer, a laptop, etc.) may also be used to control the display apparatus 200. For example, the display apparatus 200 is controlled using an application running on the smart device 300.

In some embodiments of the disclosure, the display apparatus may not use the above-mentioned smart device or control device to receive instructions, but may receive control from a user through touch or gestures.

In some embodiments of the disclosure, the display apparatus 200 may also be controlled in a manner other than the control device 100 and the smart device 300. For example, the display apparatus 200 may be controlled by a voice command directly received from the user through a module configured inside the display apparatus 200 for obtaining voice commands, or the display apparatus 200 may be controlled by a voice command received from the user through a voice control device provided outside the display apparatus 200.

In some embodiments of the disclosure, the display apparatus 200 further performs data communication with a server 400. The display apparatus 200 may be allowed to perform the communication through a Local Area Network (LAN), a Wireless Local Area Network (WLAN), and other networks. The server 400 can provide various content and interactions to the display apparatus 200.

The server 400 may be a server that provides various services, such as a backend server that provides support for audio data collected by the display apparatus 200. The backend server can analyze and process the received audio and other data, and feed processing results back to a terminal device.

FIG. 2 is a block diagram of a configuration of the control device 100 in some embodiments of the disclosure. As shown in FIG. 2, the control device 100 can include at least one processor, a communication interface, a user input/output interface, a memory, and a power supply. The control device 100 may receive an operation command input from the user, and convert the operation command into an instruction that the display apparatus 200 may identify and respond to, so as to realize an effect of an interaction medium between the user and the display apparatus 200.

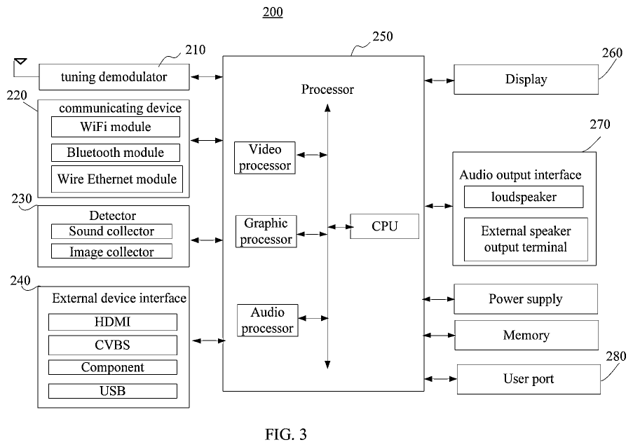

FIG. 3 is a block diagram of a configuration of a display apparatus 200 according to some embodiments of the disclosure.

The display apparatus 200 can include at least one of a tuning demodulator 210, a communicating device 220, a detector 230, an external device interface 240, at least one processor 250, a display 260, an audio output interface 270, a memory, a power supply, and a user port 280.

In some embodiments of the disclosure, the at least one processor may include a video processor, an audio processor, a graphics processor, and the like.

In some embodiments of the disclosure, the tuning demodulator 210 receives signals from a broadcast system through a wired or wireless receiving manner, and demodulates audio and video signals and EPG data signals from multiple wireless or wired broadcast television signals.

In some embodiments of the disclosure, the communicating device 220 is a component for communicating with an external device or a server according to various types of communication protocols. For example, the communicating device may include at least one of a Wi-Fi module, a Bluetooth module, a wired Ethernet module, other network communication protocol chip or near-field communication protocol chip, and an infrared receiver. The display apparatus 200 can establish transmission and reception of control signals and data signals with the control device 100 or the server 400 through the communicating device 220.

In some embodiments of the disclosure, the detector 230 is used to collect signals from external environment or signals from interaction with outside. For example, the detector 230 includes a light receiver, a sensor for collecting the intensity of the ambient light; or the detector 230 includes an image collector, such as a camera, which can be used to collect external environment scenes, attributes of the user or interaction gestures of the user; or, the detector 230 includes a sound collector, such as a microphone, etc., which is used for receiving external sounds.

The sound collector can be a microphone, also called a “speaker” or a “mike”, which can be used to receive user's voice and convert the sound signal into an electrical signal. The display apparatus 200 may be provided with at least one microphone. In other embodiments, the display apparatus 200 may be provided with two microphones, which in addition to collecting sound signals, may also implement a noise reduction function. In other embodiments, the display apparatus 200 may also be equipped with three, four or more microphones to collect sound signals, reduce noise, identify sound sources, and implement directional recording functions, etc.

In addition, the microphone may be built into the display apparatus 200, or the microphone may be connected with the display apparatus 200 in a wired or wireless manner. Of course, the position of the microphone on the display apparatus 200 is not limited in the embodiments of the disclosure. Alternatively, the display apparatus 200 may not include a microphone, that is, the microphone is not provided in the display apparatus 200. The display apparatus 200 may be connected with an external microphone (also called a speaker) through an interface (such as an USB interface 130). The external microphone can be fixed on the display apparatus 200 through an external fixing component, such as a camera bracket with a clip.

In some embodiments of the disclosure, the external device interface 240 may include, but is not limited to, any one or more of: a High Definition Multimedia Interface (HDMI) interface, an analog or data high-definition component input interface (component), a Composite Video Broadcast Signal (CVBS) input interface, a Universal Serial Bus (USB) input interface, an Audio and Video (AV) interface, an RGB port, etc.

In some embodiments of the disclosure, the processor 250 and the tuning demodulator 210 may be located in different separate devices, that is, the tuning demodulator 210 may also be located in an external device of the main device where the processor 250 is located, such as an external set-top box, etc.

In some embodiments of the disclosure, the processor 250 controls the operation of the display apparatus and responds to user's operations through various software control programs stored in the memory. The processor 250 controls the overall operation of the display apparatus 200. For example, in response to receiving a user command for selecting a UI object to be displayed on display 260, the processor 250 may perform operations related to the object selected by the user command.

In some embodiments of the disclosure, the processor 250 may include at least one of a Central Processing Unit (CPU), a video processor, an audio processor, a Graphics Processing Unit (GPU), and a Random Access Memory (RAM), a Read-Only Memory (ROM), the first to nth interfaces for input/output, a communication bus (Bus), etc.

In some embodiments of the disclosure, the display 260 may include a display screen component for presenting pictures, and a driving component for driving image display, for receiving image signals output from the processor 250, and displaying video content, image content, and components of a menu control interface and a user control UI interface.

The display 260 may be a liquid crystal display, an OLED display, or a projection display, or may be a projection device and a projection screen.

In some embodiments of the disclosure, the user may input a user command in a graphical user interface (GUI) displayed on the display 260, and the user input interface receives the user command through the graphical user interface (GUI). Alternatively, the user can input a user command by inputting a specific sound or gesture, and the user input interface recognizes the sound or gesture through a sensor to receive the user command.

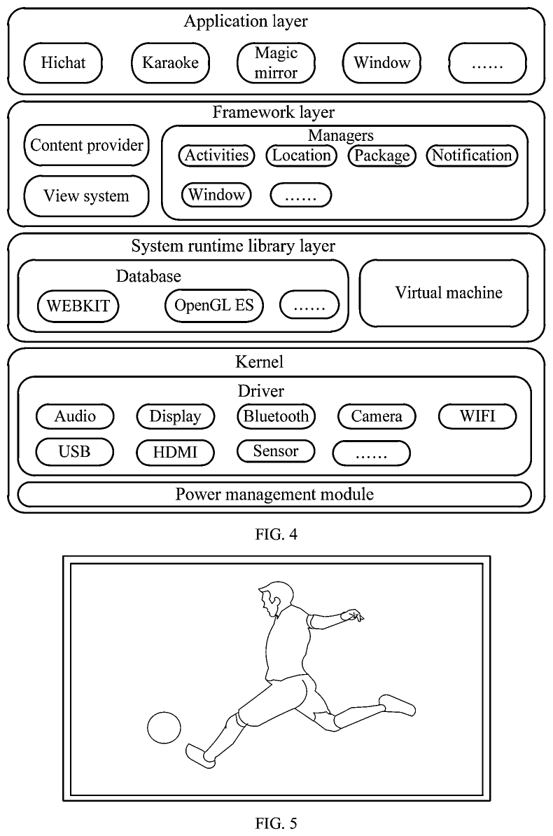

Referring to FIG. 4, in some embodiments of the disclosure, the system is divided into four layers. From top to bottom, they are an applications layer (referred to as “Application layer”) and an application framework layer (referred to as “Framework Layer”), an android runtime and system library layer (referred to as “system runtime library layer”), and a kernel layer.

In some embodiments, at least one application runs in the applications layer. These applications can be a window program, a system setting program or a clock program that comes with the operating system; or they can also be applications developed by a third-party developer. In specific implementation, the application packages in the applications layer are not limited to the above examples.

The application framework layer provides an application programming interface (API) and a programming framework for applications in the applications layer. The application framework layer can include some predefined functions. Through the API interface, the application can access the resources in the system runtime library layer and obtain system services during execution, and call the corresponding driver in the kernel layer to drive a corresponding module, so as to use corresponding resources to perform corresponding services. For example, a Bluetooth setting program that comes with the system calls Bluetooth-related resources in the system runtime library layer and a Bluetooth service of the system through a corresponding API interface, and calls a driver corresponding to the Bluetooth module in the kernel layer to drive the Bluetooth module to use related resources to execute Bluetooth services, such as searching for other Bluetooth devices through Bluetooth, receiving Bluetooth connection requests sent by other Bluetooth devices, etc.

In some embodiments of the disclosure, the kernel layer is a layer between hardware and software. As shown in FIG. 4, the kernel layer contains at least one of the following drivers: an audio driver, a display driver, a Bluetooth driver, a camera driver, a WIFI driver, a USB driver, a HDMI driver, a sensor driver (such as a fingerprint sensor, a temperature sensor, a pressure sensor, etc.), and a power driver, etc.

A variety of applications can be installed on the display apparatus 200, and the display apparatus 200 provides users with multiple functions through the applications. In some embodiments of the disclosure, a video application can be installed on the display apparatus 200, and the user can watch TV dramas, movies, etc. through the video application; a game application can also be installed on the display apparatus 200, and the user can play games through the game application; a singing application can also be installed on the display apparatus 200, and the user can use the singing application for karaoke.

Applications installed on the display apparatus 200 for playing audio and video data may be called application players. These application players can provide a wealth of network resources. However, due to development capabilities, development needs, and audience orientation of the application players are different, the audio and video data provided by the application players is also different. For example, some of the application players transfer audio and video data provided by the Internet, so the clarity and other picture quality of the audio and video data provided by the application players are lower; some of the application players are the source of the audio and video data itself, the clarity and other picture quality of the audio and video data provided by the application players are higher. The audience of some application players is sports enthusiasts, so the content of the audio and video data provided by the application players is mostly sports events. The audience of some application players is movie lovers, so the content of the audio and video data provided by the application players is mostly movies. The audience of some application players is music lovers, so the content of the audio and video data provided by the application players is mostly music.

When the above application player is used on the display apparatus 200, the application player requests audio and video data from the server 400. The server 400 encrypts and compresses the requested audio and video data, and transmits the compressed package to the application player. The application player performs unpacking through a splitter to parse out video files and audio files, and translates the encodings into common video streams and audio streams through a decoder, and then converts the video streams and audio streams into video (i.e., the audio and video data provided by the application player) through a renderer for playing on the display apparatus 200. When the audio and video data provided by the application player is played on the display apparatus 200, the display apparatus 200 uses playing parameters provided by its own video player to process the audio and video data, and displays the processed audio and video data, that is, the display apparatus 200 play the audio and video data provided by the application player using the playing parameters. For example, in the playing parameters used by the display apparatus 200, the brightness value is +20, then the display apparatus 200 increases the brightness value of the audio and video data by 20 to increase play brightness of the audio and video data. It can be seen that the playing effect of audio and video data will be affected by the playing parameters used by the display apparatus 200.

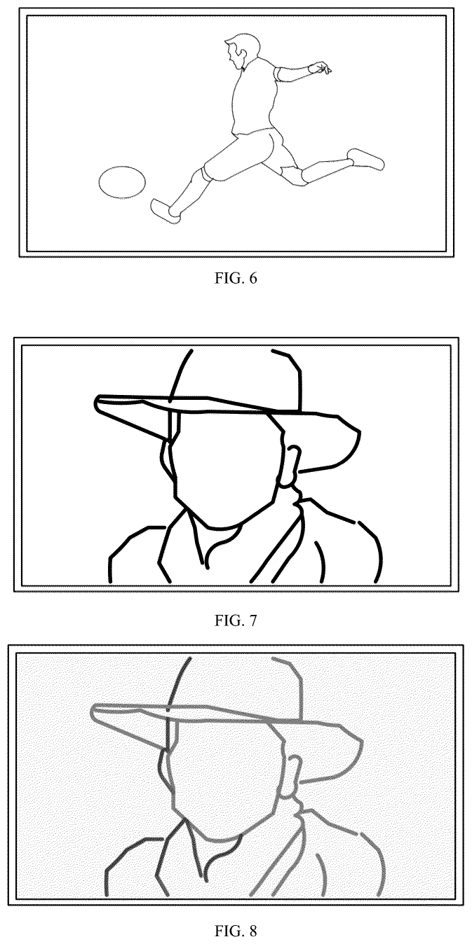

Only when the playing parameters used by the display apparatus 200 match the audio and video data, the playing effect of the audio and video data can be improved. If the playing parameters used by the display apparatus 200 do not match the audio and video data, the playing effect of the audio and video data will be reduced. The playing parameters used by the display apparatus 200 are common to the audio and video data provided by all application players. That is to say, if the playing parameters of the display apparatus 200 are not adjusted, the display apparatus 200 will use the same playing parameters to play audio and video data provided by different application players. Based on the above introduction to the audio and video data provided by the application player, the audio and video data provided by different application players are different. Taking the application player “Tencent Sports” and the application player “Disney+” as examples, the content of audio and video data a provided by the application player “Tencent Sports” is sports events, and the content of audio and video data b provided by the application player “Disney+” is movies. When playing the audio and video data a and the audio and video data b, the display apparatus 200 needs to use different playing parameters to ensure the quality of playing. When the display apparatus 200 plays the audio and video data a, it needs to use a playing parameter 1 (such as picture mode, contrast, brightness, color, tint, definition, color temperature, motion enhancement, image noise reduction, dynamic contrast, etc.). Each parameter included in the playing parameter 1 corresponds to a value suitable for watching sports events, and the display apparatus 200 uses the playing parameter 1 to better handle objects moving at high speed, such as a football moving at high speed, athletes moving at high speed, etc. As shown in FIG. 5, when the display apparatus 200 uses the playing parameter 1 to play the audio and video data a, it can obtain footballs and athletes with clear boundaries and standard shapes, thus ensuring the playing effect of the audio and video data a. When the display apparatus 200 plays the audio and video data b, it needs to use a playing parameter 2 (such as picture mode, contrast, brightness, color, tint, definition, color temperature, sharpening/blurring of image, saturation, sound mode, equalizer, synchronization of sound and picture, etc.), each parameter included in the playing parameter 2 corresponds to a value suitable for watching film and television programs, and the display apparatus 200 can use the playing parameter 2 to better process the images and sounds in the film and television programs. As shown in FIG. 7, when the display apparatus 200 uses the playing parameter 2 to play the audio and video data b, a picture with clear characters and obvious contrast between the characters and the background can be obtained, thus ensuring the playing effect of the audio and video data b. And if the display apparatus 200 uses same playing parameters when playing the audio and video data provided by each application player, for example, all use playing parameter 1, then when the display apparatus 200 uses the playing parameter 1 to play the audio and video data a, the playing effect of the audio and video data a can be guaranteed. However, when the display apparatus 200 uses the playing parameter 1 to play the audio and video data b, a picture in which the contrast between the character and the background is not obvious and the brightness is too high (exposed) will appear, as shown in FIG. 8, resulting in a poor playing effect of audio and video data b. If the display apparatus 200 uses playing parameter 2 when playing audio and video data provided by each application player, when the display apparatus 200 uses the playing parameter 2 to play the audio and video data b, the playing effect of the audio and video data b can be guaranteed. However, when the display apparatus 200 uses the playing parameter 2 to play the audio and video data a, problems such as object deformation, object tailing, and object blur will occur, as shown in FIG. 6, resulting in a poor playing effect of the audio and video data a.

When the playing parameters used by the display apparatus 200 do not match the audio and video data provided by the current application player, in order to ensure the playing effect of the audio and video data, the playing parameters used by the display apparatus 200 need to be adjusted, so that the adjusted playing parameters are consistent with the audio and video data. Taking the display apparatus 200 using the playing parameter 2 to play the audio and video data a provided by the application player “Tencent Sports” as an example, the user needs to adjust the playing parameters of the display apparatus 200 to match the audio and video data a. As can be seen from the above, the playing parameter 1 matching the audio and video data a may include multiple parameters, the adjustment operation of the user is relatively cumbersome and time-consuming, and the user may miss some program content during the process of adjusting the playing parameters, thus resulting in a poor usage experience of user. After the user adjusts the playing parameters of the display apparatus 200 from the playing parameter 2 to the playing parameter 1, if the user wants to watch the audio and video data b provided by the application player “Disney+”, based on the fact that the display apparatus 200 uses the same playing parameters to play audio and video data provided by different application players, then the display apparatus 200 uses the playing parameter 1 to play the audio and video data b, so that the playing effect is poor. In order to improve the playing effect, the user further needs to adjust the playing parameters from the playing parameter 1 to the playing parameter 2. It can be seen that when adjusting the playing parameters, since the display apparatus 200 uses the same playing parameters to play audio and video data provided by different application players, it is equivalent to adjusting the playing parameters corresponding to all application players, resulting in that even if the playing parameters are adjust to match the audio and video data that is played currently, once the display apparatus 200 is switch to other application players, that is, when playing the audio and video data provided by the other application players, the adjusted playing parameters do not match with audio and video data provided by the switched application player, and the playing parameters need to be adjusted again, therefore, the operation of the user is cumbersome and time-consuming, and the user's usage experience is poor.

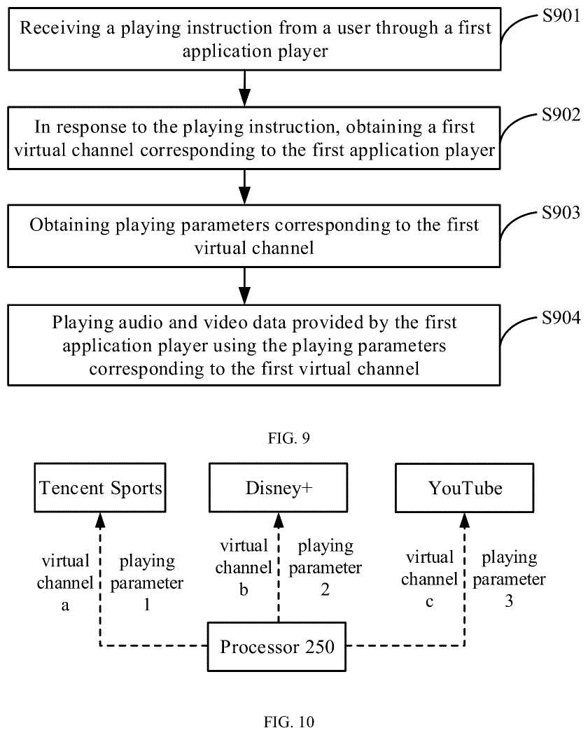

In order to solve the above problems, the embodiments of the disclosure provide a display apparatus 200 and a processing method for the display apparatus, which can be referred to the flow shown in FIG. 9, and the specific steps may include the following.

S901. Receiving a playing instruction from a user through a first application player.

In the embodiments, at least one application player is installed on the display apparatus 200, and the application player that the user wants to use is called the first application player. Each application player provides audio and video data with corresponding content based on a development direction of the operation developer. That is, according to the content of the audio and video data, application players can be categorized into single-content application players and multi-content application players. Audio and video data provided by the single-content application player only corresponds to the content of one content category. For example, a film and television application player only provides audio and video data whose content is film and television, such as Netflix, Disney+, Apple TV+, HBO max, etc.; a music application player only provides audio and video data whose content is music, such as Spotify, Apple Music, NetEase Cloud Music, QQ Music, Kuwo Music, Kugou Music, etc.; and a sports application player only provides audio and video data whose content is sports, such as Tencent Sports, CCTV Sports, etc. Audio and video data provided by the multi-content application player corresponds to the content of multiple content categories. For example, a comprehensive application player provides audio and video data whose content are film and television, music, and sports, such as YouTube, TikTok, Tencent Video, and Youku Video, iQIyI, Bilibili, etc.

The user selects the first application player to be used by controlling the control device 100 (such as a remote controller) or the smart device 300 (such as a mobile phone). In some embodiments of the disclosure, the user controls the remote controller to move a focus to an icon of the first application player, and presses a “confirm” key on the remote controller to send a selection instruction to the display apparatus 200. In response to the selection instruction, the display apparatus 200 displays a user interface of the first application player. The user interface of the first application player includes an option of resource information, where the resource information represents the content of the audio and video data. For example, if the content of the audio and video data is a football match, the resource information is the football match, and for example, if the content of the audio and video data is a movie, the resource information is the movie. For application players of different categories, the resource information also corresponds to different categories.

In some embodiments, if the first application player is a single-content application player, the resource information only contains one category, and the category of the resource information is consistent with the content category of the audio and video data provided by the first application player, for example, the content category of the audio and video data is film and television, and the category of the resource information is also film and television. The user controls the remote controller to move the focus to a specific resource option in the resource information, such as a movie name, and presses the “confirm” key on the remote controller to send a playing instruction to the display apparatus 200, to instruct the display apparatus 200 to play the movie corresponding to the movie name.

In some embodiments, if the first application player is a multi-content application player, the resource information can include multiple categories, and the multiple categories each corresponds to one of content categories of the audio and video data provided by the first application player. For example, if the content categories of audio and video data include film and television, music, and sport, the categories of resource information also include film and television, music, and sport. The user controls the remote controller to move the focus to a specific resource option in a type of resource information, such as a movie name in the film and television resource information, and presses the “confirm” key on the remote controller to send a playing instruction to the display apparatus 200, to instruct the display apparatus 200 to play the movie corresponding to the movie name.

S902. In response to the playing instruction, obtaining a first virtual channel corresponding to the first application player, where different application players in the display apparatus correspond to different virtual channels, and each virtual channel is provided with independent playing parameters.

In response to the play instruction, the display apparatus 200 obtains corresponding audio and video data from the first application player, and plays the audio and video data. As can be seen from the above, when playing audio and video data, the display apparatus 200 uses the playing parameters that have been configured in the display apparatus 200. In order to enable the display apparatus 200 to accurately use the playing parameters corresponding to the audio and video data provided by the first application player to play the audio and video data, in the embodiments of the disclosure, virtual channels are pre-configured in the display apparatus 200 to separately manage the playing parameters corresponding to each of the application players through the respective virtual channels.

A virtual channel in this disclosure is a concept similar to a physical channel, derived from the concept of the physical channel, but opposite to the concept of a physical channel. The physical channel is a channel that relies on physical cables to transmit information and calls the data of the corresponding hardware by a corresponding driver in the kernel layer for audio and video encoding and decoding. For example, a channel formed in existing TV equipment by connecting to the TV equipment through a physical hardware cable such as an HDMI cable and an AV cables. A virtual channel corresponds to a physical channel. In the disclosure, the virtual channel refers to a channel that calls the data of the corresponding hardware by the corresponding driver in the kernel layer for audio and video encoding and decoding, but does not or does not necessarily rely on physical cables to transmit information. For example, for network streaming media application players such as YouTube, Netflix, and Disney+, the respective corresponding audio and video resources are directly transmitted to the TV equipment through the Internet, and the specific hardware transmission method may be that the respective corresponding audio and video resources are transmitted to the TV equipment by using the same Ethernet Cable or by using wireless manner. However, in the disclosure, at least one audio and video codec data transmission channel that is isolated from each other at the kernel layer will be provided for each streaming media application player, and then the above-mentioned channels implemented on the kernel layer are referred to as virtual channels in the disclosure.

Each application player on the display apparatus 200 has a corresponding virtual channel, that is, each application player corresponds to at least one virtual channel, and different application players correspond to different virtual channels to prevent each application player from repeatedly corresponding to the same virtual channel. Moreover, each virtual channel is provided with playing parameters. As the virtual channels are isolated from each other at the kernel layer, the playing parameters configured for each of the virtual channels are also isolated from each other. That is, the playing parameters configured for each virtual channel do not affect each other. In other words, the playing parameters configured for each virtual channel are independent playing parameters. Each application player running on the application layer calls the audio and video data that is encoded or decoded in the corresponding virtual channel on the kernel layer through the data transfer architecture of the operating system.

In embodiment 1, each application player corresponds to one virtual channel. If the application player is a single-content application player, the display apparatus 200 uses the playing parameters configured for the virtual channel to play the audio and video data provided by the application player that only corresponds to one content category. If the application player is a multi-content application player, the display apparatus 200 uses the playing parameters configured for the virtual channel to play the audio and video data of each content category provided by the application player. That is to say, the audio and video data of each content category of the application player uses the same set of playing parameters. As shown in FIG. 10, the application player “Tencent Sports” corresponds to a virtual channel a, and the virtual channel a is provided with a playing parameter 1; the application player “Disney+” corresponds to a virtual channel b, and the virtual channel b is provided with a playing parameter 2; the application player “YouTube” corresponds to a virtual channel c, and the virtual channel c is provided with a playing parameter 3. The application player “Tencent Sports” is a single-content application player and provides audio and video data with a content category of sports (shown in a dotted box), the application player “Disney+” is a single-content application player and provides audio and video data with a content category of film and television (shown in a dotted box), and the application player “YouTube” is a multi-content application player, providing audio and video data with content categories of sports, and film and television (shown in a dotted box). The display apparatus 200 controls each application player through the processor 250. Therefore, in FIG. 10, by showing the relationship between the processor 250 and each application player, the relationship between the display apparatus 200 and each application player is shown. In FIG. 10, each virtual channel is shown with a dotted line, and the arrows indicate management relationships between the processor 250 and corresponding application players through the respective virtual channels. It can be seen that the display apparatus 200 manages the playing parameters of each application player individually through each virtual channel with the application player as the smallest unit. That is, the display apparatus 200 uses the playing parameter 1 to play the audio and video data provided by the application player “Tencent Sports”, the display apparatus 200 uses the playing parameter 2 to play the audio and video data provided by the application player “Disney+”, and the display apparatus 200 uses the playing parameter 3 to play the audio and video data provided by the application player “YouTube”.

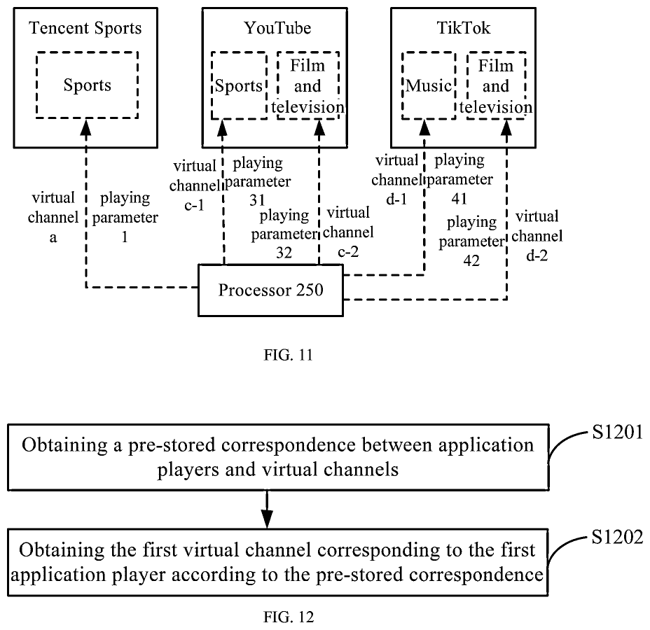

In embodiment 2, a single-content application player corresponds to one virtual channel, and a multi-content application player corresponds to a group of virtual channels. The correspondence between the single-content application player and the virtual channel can be referred to the description in the embodiment 1, which will not be repeated here. One content category of the audio and video data provided by the multi-content application player corresponds to one virtual channel, and different content categories correspond to different virtual channels to prevent different content categories from corresponding to the same virtual channel at the same time. Thus, the display apparatus 200 plays the audio and video data provided by the corresponding application player using the playing parameters set for the virtual channel corresponding to each application player, so as to realize independent management of the playing parameters of each application player through the virtual channel. Further, the display apparatus 200 plays the audio and video data of each content category using the playing parameters set for the respective virtual channels corresponding to the multi-content application player, so as to realize separate management of the audio and video data of each content category through the playing parameters set for the virtual channels, so that the accuracy of using playing parameters can be further improved. As shown in FIG. 11, the application player “Tencent Sports” corresponds to a virtual channel a, and the virtual channel a is provided with a playing parameter 1; the application player “YouTube” corresponds to virtual channels c-1 and c-2, and the virtual channel c-1 is provided with a playing parameter 31 and the virtual channel c-2 is provided with a playing parameter 32; the application player “TikTok” corresponds to virtual channels d1 and d2, the virtual channel d1 is provided with a playing parameter 41, and the virtual channel d2 is provided with a playing parameter 42. Among them, the application player “Tencent Sports” is a single-content application player that provides audio and video data with the content category of sports (shown in a dotted box), the application player “YouTube” is a multi-content application player that provides audio and video data with the content category of sports, and film and television (shown in a dotted box), the application player “TikTok” is a multi-content application player that provides audio and video data with content categories of music, and film and television (shown in a dotted box). In FIG. 11, the relationship between the display apparatus 200 and each application player is still shown by showing the relationship between the processor 250 and each application player. In FIG. 11, each virtual channel is shown with a dotted line, and the arrows indicate management relationships between the processor 250 and the respective application players through the respective virtual channels. It can be seen that the display apparatus 200 uses the playing parameter 1 to play the audio and video data provided by the application player “Tencent Sports”; the display apparatus 200 uses the playing parameter 31 to play the audio and video data provided by the application player “YouTube” with the content category of sports, and the display apparatus 200 uses the playing parameter 32 to play the audio and video data provided by the application player “YouTube” with the content category of film and television; and the display apparatus 200 uses the playing parameter 41 to play the audio and video data provided by the application player “TikTok” with the content category of music, and the display apparatus 200 uses the playing parameter 42 to play the audio and video data provided by the application player “TikTok” with the content category of film and television.

Thus, the display apparatus 200 can separately manage the playing parameters configured for each virtual channel by separately managing each virtual channel, to realize separately management of the playing data corresponding to each application player, thus the display apparatus 200 can directly use the playing parameters corresponding to the first application player to play the audio and video data provided by the first application player, so that the playing parameters used by the first application player to accurately match the audio and video data to improve the playing effect.

A virtual channel corresponding to the first application player may be determined with reference to the flow shown in FIG. 12, and the specific steps may include the following.

S1201. Obtaining a pre-stored correspondence between application players and virtual channels, where the pre-stored correspondence includes a correspondence between identification information of the application players and identification information of the virtual channels.

After the display apparatus 200 is powered on, a monitoring service is started to monitor the launch of the application player at the application layer. In the embodiments, the display apparatus 200 can monitor the launch of the first application player, and determine the virtual channel corresponding to the first application player (i.e., the first virtual channel) based on the pre-stored correspondence between the application players and the virtual channels.

In embodiment 3, when installing an application player, the display apparatus 200 obtains the identification information of the application player. The identification information of the application player may be an icon, a name, an ID, an installation package name, etc. of the application player that uniquely identifies the application player. The display apparatus 200 directly creates a virtual channel for each application player (refer to the embodiment 1), constructs and stores the correspondence between the identification information of the application players and the identification information of the virtual channels. The identification information of the virtual channels may be information that can uniquely identify the virtual channels such as a number and a name. In an embodiment of the disclosure, a correspondence between the application player “Tencent Sports” and the virtual channel a is expressed as “com.tencent.qqsports-a”, herein, “com.tencent.qqsports” is the installation package name of the application player “Tencent Sports”, the installation package name is used as identification information, and “a” is the identification information of the virtual channel a.

In embodiment 4, when installing an application player, the display apparatus 200 obtains the identification information of the application player and also obtains the application information of the application player. The application information includes a content category of audio and video data provided by the application player or a category of the application player, and the display apparatus 200 can determine the category of the application player according to the application information. If the application player is a single-content application player, one virtual channel is created for the application player (refer to the embodiment 1). The display apparatus 200 constructs and stores a correspondence between the identification information of the application player and the identification information of the virtual channel, herein, the identification information of the application player, the identification information of the virtual channel, and the correspondence between the identification information of the application player and the identification information of the virtual channel can be refer to the embodiment 3 and will not be repeated herein. If the application player is a multi-content application player, a group of virtual channels is created for the application player (refer to the embodiment 2). The display apparatus 200 constructs and stores a correspondence between the identification information of the application player and the identification information of the virtual channels, herein, the identification information of the application player includes first identification information and second identification information. The first identification information can be referred to the embodiment 3 for uniquely identifying the application player, which will not be repeated herein. The second identification information includes a number, a name, etc., and is used to uniquely identify the content category in the application player. The first identification information and the second identification information are located in different mark positions, which are used to quickly distinguish the two types of identification information. The identification information of the virtual channels includes third identification information and fourth identification information. The third identification information refers to the group identification information of the group of virtual channels, including a number, a name, etc., and is used to uniquely identify the group of virtual channels. The fourth identification information includes a number, a name, etc., and is used to uniquely identify the virtual channel in the group of virtual channels. The third identification information and the fourth identification information are located in different mark positions, which are used to quickly distinguish the two types of identification information. Therefore, the correspondence between the identification information of the application player and the identification information of the virtual channels is equivalent to a correspondence between a combination of the first identification information and the second identification information of the application player and a combination of the third identification information and the fourth identification information of the virtual channel.

In an embodiment of the disclosure, the application player “YouTube” is a multi-content application player that provides audio and video data in the content categories of sports, and film and television. The display apparatus 200 creates a group of virtual channels for it, including two virtual channels, and a correspondence between the application player “YouTube” and the group of virtual channels include “(com.google.android.youtube.tv-1)-(Youtube-1)” and “(com.google.android.youtube.tv-2)-(Youtube-2)”, herein, “com. com.google.android.youtube.tv” in “com.google.android.youtube.tv-1” and “com.google.android.youtube.tv-2” is the installation package name of application player C, as the first identification information, “1” in “com.google.android.youtube.tv-1” and “2” in “com.google.android.youtube.tv-2” are the second identification information of the application player “YouTube”, which identify the content categories of sports, and film and television, respectively. “Youtube” in “Youtube-1” and “Youtube-2” is the third identification information of the virtual channel group, and “1” “Youtube-1” and “2” “Youtube-2” are the fourth identification information of the virtual channel group, which identify the virtual channels corresponding to the content categories of sports, and film and television, respectively.

Based on the embodiment 3 and embodiment 4, the display apparatus 200 can directly constructs a corresponding virtual channel for the application player when installing the application player.

In embodiment 5, based on the virtual channel constructed in the embodiment 3 and embodiment 4, the display apparatus 200 detects an update notification of the application player or receives an update notification of the application player, and modifies the virtual channel of the application player that has been updated based on the update notification. The update notification includes a type of application player and change information of the content category corresponding to the audio and video data provided by the application player. For example, the application player is updated from a single-content application player to a multi-content application player, and then the application player adds the content category of the provided audio and video data; or the application player is updated from a multi-content application player to a single-content application player, and then the application player deletes the content category of the provided audio and video data. Correspondingly, the display apparatus 200 modifies one virtual channel corresponding to the application player to a group of virtual channels corresponding to the application, and then the display apparatus 200 adds a virtual channel corresponding to the newly added content category to the group of virtual channels corresponding to the application player; or the display apparatus 200 modifies a group of virtual channels corresponding to the application player to one virtual channel corresponding to the application player, and then the display apparatus 200 deletes the virtual channel corresponding to the deleted content category from the group of virtual channels corresponding to the application player. Therefore, the display apparatus 200 dynamically constructs a virtual channel corresponding to each application player to ensure the accuracy of the correspondence between the virtual channels and the application players, thereby ensuring the correctness of the playing parameters that are used, and ensuring the playing effect.

Based on the embodiment 3, the embodiment 4 and the embodiment 5, the correspondence between application players and virtual channels can be obtained. The display apparatus 200 stores the correspondence in advance, so that the virtual channel can later be determined directly based on the correspondence.

S1202. Obtaining the first virtual channel corresponding to the first application player according to the pre-stored correspondence.

When the display apparatus 200 monitors that the first application player is launched, it identifies the identification information of the first application player, and determines the identification information of the first virtual channel corresponding to the identification information of the first application player according to the pre-stored correspondence, and further determines the first virtual channel according to the identification information of the first virtual channel.

Regarding the correspondence constructed in the embodiment 3, the display apparatus 200 can determine the identification information of the first virtual channel according to the correspondence and the identification information of the first application player, herein, the first virtual channel only includes one virtual channel.

Regarding the correspondence constructed in the embodiment 4, the display apparatus 200 can determine the identification information of the first virtual channel according to the correspondence and the identification information of the first application player, herein the display apparatus 200 can determine the first virtual channel corresponding to the first application according to the identification information of the first virtual channel and the third identification information of each group of virtual channels in the correspondence. If the first application player is a single-content application player, the first virtual channel includes only one virtual channel; if the first application player is a multi-content application player, the first virtual channel includes multiple virtual channels.

S903. Obtaining playing parameters corresponding to the first virtual channel.

Corresponding playing parameters are configured for each virtual channel, that is, there is a correspondence between each virtual channel and playing parameters configured for it. In some embodiments, if the user has never configured corresponding playing parameters for the application player, the playing parameters configured for the virtual channel corresponding to the application player are all default values. In an embodiment of the disclosure, the virtual channel a corresponding to the application player “Tencent Sports” is provided with the playing parameter 1, that is, there is a correspondence between the virtual channel a and the playing parameter 1. The virtual channels c-1 and c-2 corresponding to the application player “YouTube” are provided with playing parameters 31 and playing parameters 32, respectively, that is, there is a correspondence between the virtual channel c-1 and the playing parameter 31, and there is a correspondence between the virtual channel c-2 and the playing parameter 321.

The display apparatus 200 stores the correspondence between each virtual channel and playing parameters in advance. In some embodiments, the correspondence can be a correspondence between the identification information of the virtual channels and memory addresses (such as a MAC address) of the playing parameters. For example, “a-1F:B9:41:50:F8:7E (the memory address of the playing parameter 1)”, “(c-1)-34:31:58:3B:EC:1C (the memory address of the playing parameter 31)”, and “(c-2)-C4:E0:21:7B:68:B2 (the memory address of the playing parameter 32)”.

Based on the first virtual channel determined in S902 and the above correspondence between the virtual channels and the playing parameters, the display apparatus 200 may obtain the playing parameters corresponding to the first virtual channel.

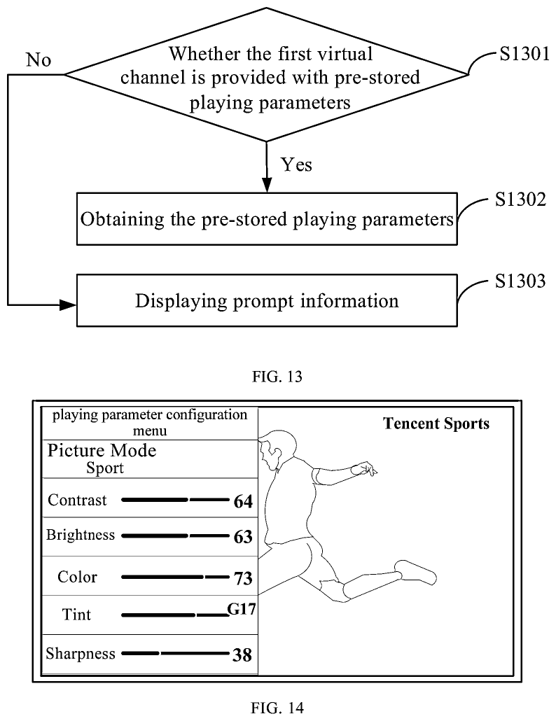

In embodiment 6, for the first virtual channel including only one virtual channel, the playing parameters of the first virtual channel can be obtained with reference to the flow shown in FIG. 13, and the specific steps may include the following.

S1301. Determining whether the first virtual channel is provided with pre-stored playing parameters.

The display apparatus 200 obtains the identification information of the first virtual channel, such as “a”, and determines that the memory address of the playing parameters corresponding to the first virtual channel is “1F:B9:41:50:F8:7E” according to the correspondence “a-1F:B9:41:50:F8:7E” between the identification information of the virtual channel and the memory address of the playing parameters. The display apparatus 200 can obtain the playing parameters, i.e., the playing parameter 1, corresponding to the first virtual channel according to “1F:B9:41:50:F8:7E”.

S1302. Based on that the first virtual channel is provided with the pre-stored playing parameters, obtaining the pre-stored playing parameters.

The display apparatus 200 obtains the playing parameters according to the memory address of the playing parameters, and configures the obtained playing parameters as the playing parameters used currently. The process in which the display apparatus 200 configures the obtained playing parameters as the playing parameters used currently is a background configuration process, that is, the user will not perceive the configuration process. The user can instruct the display apparatus 200 to display the playing parameter configuration menu, herein, the playing parameter configuration menu includes various parameter options, and values of various parameter options are consistent with the playing parameters used currently, that is, they corresponds to the first application player used currently. The user can quickly learn the playing parameters used currently through various parameter options in the playing parameter configuration menu.

In some embodiments of the disclosure, the first application player may be the application player “Tencent Sports” (which only provides audio and video data with the content category of sports), and the display apparatus 200 determines that the identification information of the first virtual channel is a according to the correspondence “com.tencent.qqsports-a” between the identification information of the application player and the identification information of the virtual channel. The display apparatus 200 determines that the memory address of the playing parameters of the first virtual channel is “87:10:8E:4F:D9:30” according to the correspondence “a-87:10:8E:4F:D9:30” between the identification information of the virtual channel and the memory address of the playing parameters. The display apparatus 200 obtains the playing parameter 1 according to “87:10:8E:4F:D9:30”, and the playing parameter 1 is not empty, that is, there are pre-stored playing parameters. For example, the playing parameter 1 includes: Picture Mode, which is set to a motion enhancement (Sport) mode; Contrast, which is set to 64; Brightness, which is set to 63; Color, which is set to 73; Tint, which is set to G17; Sharpness, which is set to 38. The display apparatus 200 configures the playing parameter 1 as the playing parameter used currently for playing the audio and video data provided by the application player A. At this time, if the user instructs the display apparatus 200 to display the playing parameter configuration menu, the playing parameter configuration menu is as shown in FIG. 14, and each parameter option in the playing parameter configuration menu is consistent with each parameter in playing parameter 1.

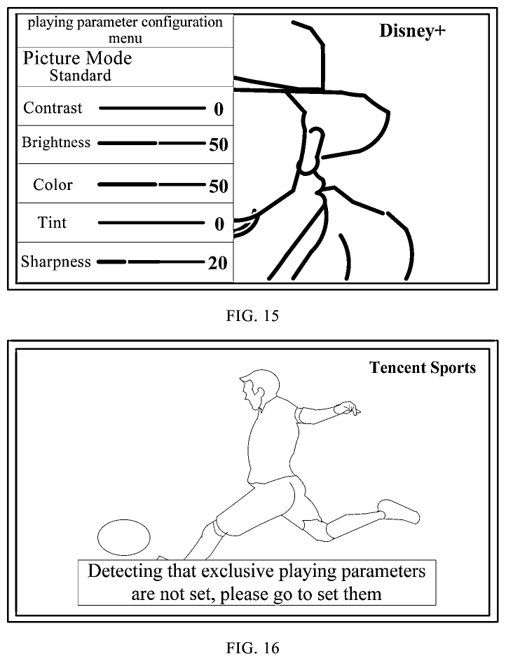

In another embodiment of the disclosure, the first application player is the application player “Disney+” (which only provides audio and video data with content category of film and television), and the display apparatus 200 determines that the identification information of the first virtual channel is b according to the correspondence “com.disney.disneyplus-b” between the identification information of the application player and the identification information of the virtual channel. The display apparatus 200 determines that the memory address of the playing parameters of the first virtual channel is “75:1C:ED:1B:B1:7B” according to the correspondence “b-75:1C:ED:1B:B1:7B” between the identification information of the virtual channel and the memory address of the playing parameters. The display apparatus 200 obtains the playing parameter 2 according to “75:1C:ED:1B:B1:7B”, and the playing parameter 2 is not empty, that is, there are pre-stored playing parameters. For example, the playing parameter 2 includes: Picture Mode, which is set to a standard mode; Contrast, which is set to 0; Brightness, which is set to 50; Color, which is set to 50; Tint, which is set to 0; Sharpness, which is set to 25. The display apparatus 200 configures the playing parameter 2 as the playing parameter used currently for playing the audio and video data provided by the application player B. At this time, if the user instructs the display apparatus 200 to display the playing parameter configuration menu, the playing parameter configuration menu is as shown in FIG. 15, and each parameter option in the playing parameter configuration menu is consistent with each parameter in playing parameter 2.

The above two embodiments are only examples of options in the playing parameters. Based on different scenarios, the playing parameter configuration menu can include corresponding parameter options.

S1303. Based on that the first virtual channel is not provided with the pre-stored playing parameters, displaying prompt information to instruct the user to configure the playing parameters corresponding to the first virtual channel.

All the playing parameters obtained by the display apparatus 200 are default values, which means that there are no preset playing parameters, that is, the first application player have not been configured with the playing parameters. The display apparatus 200 can first configure the playing parameters with default values as the playing parameters used currently, and display the prompt information. As shown in FIG. 16, the prompt information “Detecting that exclusive playing parameters are not set, please go to set them” is displayed on a play interface of the audio and video data, to prompt the user to individually adjust the playing parameters of the first application player, to make the playing effect more in line with the user's needs.

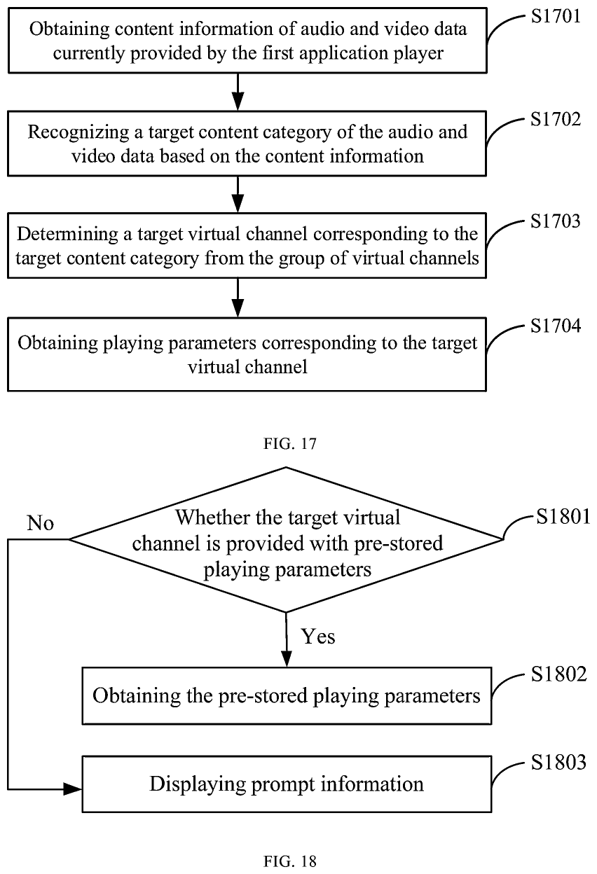

In embodiment 7, for the first virtual channel is a group of virtual channels, that is, the first virtual channel can include multiple virtual channels, obtaining the playing parameters of the first virtual channel can be obtained with reference to the flow shown in FIG. 17, and the specific steps may include the following.

S1701. Obtaining content information of audio and video data currently provided by the first application player.

In S1202, for the correspondence constructed in the embodiment 4, the first application player is a multi-content application player, that is, audio and video data with multiple content categories can be provided. The display apparatus 200 determines that the first virtual channel includes multiple virtual channels, and each virtual channel corresponds to one content category. At this time, the display apparatus 200 needs to determine a virtual channel used currently, i.e. a target virtual channel, from the group of virtual channels. The target virtual channel is determined according to a correspondence between each of the group of virtual channels and the content category of the audio and video data.

The display apparatus 200 first recognizes the content information of the audio and video data currently provided by the first application player, and the content information refers to information that can reflect and recognize the content category. In some embodiments, based on the process of the user sending the playing instruction described in S901 (the user sends the playing instruction based on resource information, where a category of the resource information corresponds to the content category), the display apparatus 200 can obtain the category of the resource information indicated by the playing instruction, that is, the content information of the audio and video data. In some embodiments, based on the process of the user sending the playing instruction described in S901 (the user sends the playing instruction according to a specific resource option in the resource information), the display apparatus 200 can obtain a name of the resource option indicated by the playing instruction, that is, the content information of the audio and video data. In some embodiments, the display apparatus 200 first plays the audio and video data provided by the first application player using the playing parameters that is used before launching the first application player, and recognizes picture content, i.e., the content information, of the audio and video data provided by the first application player through a method such as picture recognition.

S1702. Recognizing a target content category of the audio and video data based on the content information.

Based on the content information obtained in S1701, the content category, i.e., the target content category, of the audio and video data is recognized.

In some embodiments of the disclosure, content information is a category of resource information. According to the correspondence between the category of the resource information and the content category of the audio and video data (refer to the above introduction and will not be repeated here), the target content category of the audio and video data to be played can be determined. In some embodiments of the disclosure, if the category of the resource information is film and television, the target content category is film and television.

In some embodiments of the disclosure, the content information is the name of the resource option. The name of the resource option can identify the content of the corresponding audio and video data, and then the corresponding content category is analyzed based on a resource database (including a name and a content category of the resource). In some embodiments of the disclosure, if the name of the resource option is football match, it can be determined that the content of the audio and video data is football match, and it is further determined that the target content category of the audio and video data is sports.

In some embodiments of the disclosure, the content information is picture content of the audio and video data. The display apparatus 200 can determine the content category corresponding to the picture content according to the picture content. In some embodiments of the disclosure, the picture content is a football and an athlete, and the display apparatus 200 analyzes and determines that the corresponding target content category is sport based on the picture content. In some embodiments, in order to improve the accuracy of picture content recognition, the recognition time may be extended. It is also possible to focus on recognizing designated areas, such as the four corners of the picture where resource names are usually displayed.

S1703. Determining a target virtual channel corresponding to the target content category from the group of virtual channels.

Based on the correspondence between the virtual channels and the content categories, such as the correspondence between the second identification information of the application player and the fourth identification information of the virtual channel as described in the embodiment 4, the virtual channel corresponding to the target content, i.e., the target virtual channel, can be determined.

In some embodiments of the disclosure, the first application player is the application player “YouTube” (providing audio and video data with content classified as sports and film and television). If the display apparatus 200 recognizes that the target content category is sports, the correspondence between the second identification information of the application player and the fourth identification information of the virtual channel is “(com.google.android.youtube.tv-1)-(c-1)”, herein, the “1” in the “com.google.android.youtube.tv-1” uniquely identifies the content category as sports, and the fourth identification information corresponding to the target virtual channel is determined as 1, and the display apparatus 200 can determine the target virtual channel c-1 according to the fourth identification information 1. If the display apparatus 200 recognizes that the target content category is film and television, the correspondence between the second identification information of the application player and the fourth identification information of the virtual channel is “(com.google.android.youtube.tv-2)-(c-2)”, herein, the “2” in “com.google.android.youtube.tv-2” uniquely identifies the content category as film and television, the fourth identification information corresponding to the target virtual channel is determined as 2, and the display apparatus 200 can determine the target virtual channel c-2 according to the fourth identification information 2.

S1704. Obtaining playing parameters corresponding to the target virtual channel.

The display apparatus 200 obtains the playing parameters corresponding to the target virtual channel according to a correspondence between each virtual channel and the playing parameters configured therefor (refer to the correspondence between the identification information of the virtual channels and the memory addresses of the playing parameters described in S903, which will not be repeated here). The playing parameters of the target virtual channel can be obtained with reference to the flow shown in FIG. 18, and the specific steps may include the following.

S1801. Determining whether the target virtual channel is provided with pre-stored playing parameters.

In some embodiments of the disclosure, the display apparatus 200 obtains the identification information of the target virtual channel, such as “c-1”, then determines that the memory address of the playing parameters corresponding to the target virtual channel is “34:31:58:3B:EC:1C” according to the correspondence “(c-1)-34:31:58:3B:EC:1C” between the identification information of the virtual channel and the memory address of the playing parameters, so that the display apparatus 200 can obtain the playing parameters, i.e., the playing parameter 31, corresponding to the target virtual channel according to “34:31:58:3B:EC:1C”.

In some embodiments of the disclosure, the display apparatus 200 obtains the identification information of the target virtual channel, such as “c-2”, then determines that the memory address of the playing parameters corresponding to the target virtual channel is “C4:E0:21:7B:68:B2” according to the correspondence “(c-2)-C4:E0:21:7B:68:B2” between the identification information of the virtual channel and the memory address of the playing parameter, so that the display apparatus 200 can obtain the playing parameter, i.e., playing parameter 32, corresponding to the target virtual channel according to “C4:E0:21:7B:68:B2”.

S1802. Based on that the target virtual channel is provided with the pre-stored playing parameters, obtaining the pre-stored playing parameters.

The display apparatus 200 obtains the playing parameters according to the memory address of the playing parameters, and configures the obtained playing parameters as the playing parameters used currently.

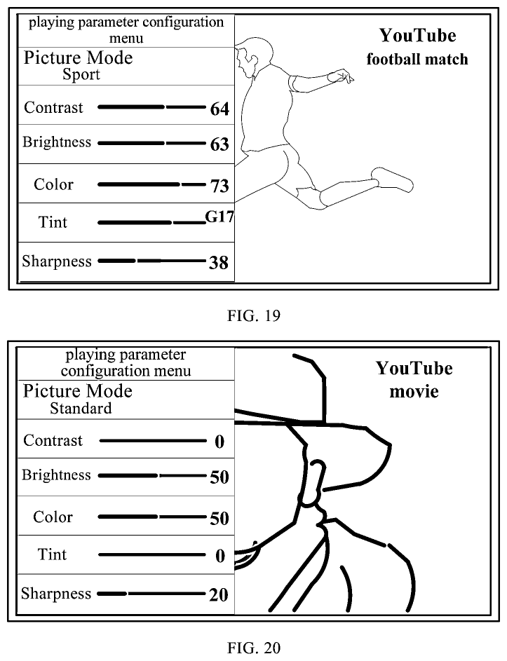

For the same first application player, if audio and video data of different content categories are played, the display apparatus 200 will configure playing parameters corresponding to the corresponding content categories. In some embodiments of the disclosure, if the application player “YouTube” plays the audio and video data with the content category of sports, the playing parameter 31 corresponding to the virtual channel c-1 is configured. At this time, if the playing parameter configuration menu is displayed, each parameter option in the playing parameter configuration menu is consistent with each parameter in the playing parameter 31, as can be seen in FIG. 19. If the audio and video data with content category of film and television is played, the playing parameter 32 corresponding to the virtual channel c-2 is configured. At this time, if the playing parameter configuration menu is displayed, each parameter option in the playing parameter configuration menu is consistent with the playing parameter 32, as can be seen in FIG. 20.

S1803. Based on that the target virtual channel is not provided with the pre-stored playing parameters, displaying prompt information to instruct the user to configure playing parameters corresponding to the target virtual channel.

If all the playing parameters obtained by the display apparatus 200 are default values, it means that there are no preset playing parameters, that is, the target content category in the first application player is not provided with playing parameters. The display apparatus 200 may first configure these playing parameters with default values as the playing parameters used currently, and displays prompt information, which may refer to FIG. 16, to prompt the user to individually adjust the playing parameters of the target content category in the first application player, to make the playing effect more in line with user's needs.

S904. Playing audio and video data provided by the first application player using the playing parameters corresponding to the first virtual channel.

Through S903, the display apparatus 200 configures the obtained playing parameters as the playing parameters used currently, and uses the playing parameters to play the audio and video data provided by the first application player. Since the playing parameters match the audio and video data provided by the first application player, the playing effect can be effectively guaranteed (refer to the playing effects shown in FIG. 5 and FIG. 7), thereby avoiding the playing effects shown in FIG. 6 and FIG. 8.

As such, based on the virtual channel configured for each application player and the independent playing parameters configured for each virtual channel, it is possible to realize configuring matching playing parameters for the audio and video data provided by each application player. After monitoring the launch of the first application player, the display apparatus 200 can quickly and accurately determine the first virtual channel corresponding to the first application player from the respective virtual channels, and can further obtain the playing parameters corresponding to the first virtual channel. The playing parameters match the audio and video data provided by the first application player. Therefore, the display apparatus 200 uses the playing parameters to play the audio and video data provided by the first application player, which can effectively ensure the playing effect.

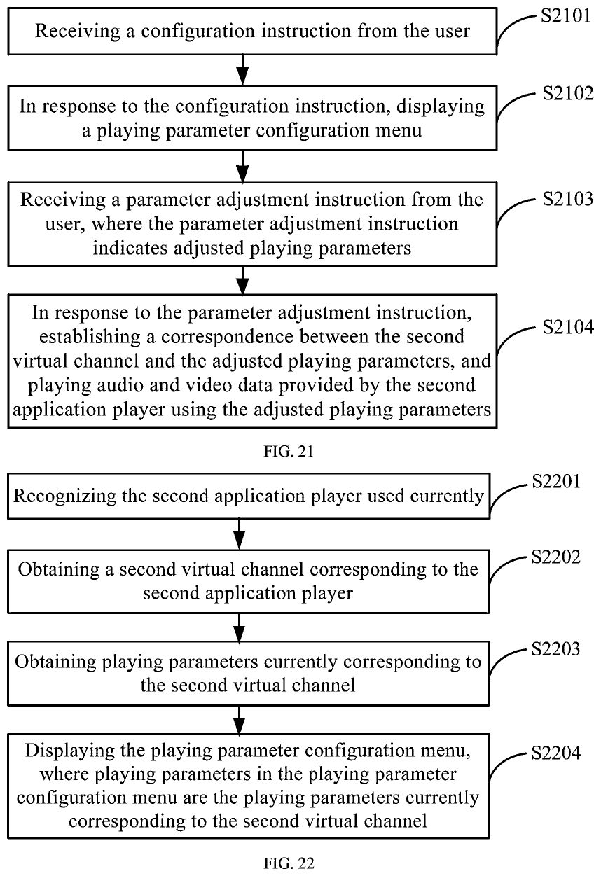

In some embodiments of the disclosure, if the user needs to adjust the playing parameters to meet the current playing requirements when using the application player, the flow shown in FIG. 21 can be referred, and the specific steps may include the following.

S2101. Receiving a configuration instruction from the user.

The user can adjust the playing parameters of the application player when using any application player. In the embodiments, the application player currently used by the user is called a second application player.

When the display apparatus 200 plays audio and video data provided by the second application player, the user sends a configuration instruction to the display apparatus 200 by controlling the control device 100 (such as a remote controller) or the smart device 300 (such as a mobile phone). In some embodiments of the disclosure, the user controls the remote controller to move a focus to setting options of the display apparatus 200 (note that it is not the setting options of the second application player), and presses the “confirm” key on the remote controller to send the configuration instruction to the display apparatus 200. Alternatively, the user presses the “set” key on the remote controller to send the configuration instruction to the display apparatus 200. The configuration instruction is used to instruct the display apparatus 200 to display a playing parameter configuration menu. The playing parameter configuration menu can include various parameter options, and the various parameter options in the playing parameter configuration menu are consistent with playing parameters currently configured for a second virtual channel corresponding to the second application player. The playing parameter configuration menu can be referred to the descriptions in the embodiment 6 and the embodiment 7 above, which will not be repeated herein.

S2102. In response to the configuration instruction, displaying a playing parameter configuration menu.

The display apparatus 200 displays the playing parameter configuration menu in response to the configuration instruction, which can be referred to the flow shown in FIG. 22, and the specific steps may include the following.

S2201. Recognizing the second application player used currently.

The display apparatus 200 can recognize the second application player used currently by monitoring the launch of the application player. The monitoring process can refer to the above process of monitoring the launch of the first application player, which will not be repeated herein.

S2202. Obtaining a second virtual channel corresponding to the second application player.

The display apparatus 200 obtains the second virtual channel corresponding to the second application player according to the correspondence between the application players and the virtual channels (refer to the correspondence between the application players and the virtual channels described above, for example, the correspondence between the identification information of the application players and the identification information of the virtual channels, which will not be repeated herein). Herein, according to the correspondence described in the embodiment 3, the second virtual channel only includes one virtual channel. According to the correspondence provided in the embodiment 4 and the second application player is a single-content application player, the second virtual channel only includes one virtual channel. According to the correspondence provided in the embodiment 4 and the second application player is a multi-content application player, the second virtual channel includes a group of virtual channels. For the process of obtaining the second virtual channel, please refer to the above process of obtaining the first virtual channel corresponding to the first application player, which will not be repeated herein.

S2203. Obtaining playing parameters currently corresponding to the second virtual channel.

According to the correspondence between the virtual channel and the playing parameters configured therefor, the display apparatus 200 can obtain the playing parameters corresponding to the second virtual channel. The process by which the display apparatus 200 obtains the playing parameters corresponding to the second virtual channel may refer to the above process of obtaining the playing parameters corresponding to the first virtual channel. The playing parameters corresponding to the second virtual channel obtained by the display apparatus 200 are the playing parameters used by the display apparatus 200 when the second application player was used last time, and the playing parameters are the initial playing parameters used by the display apparatus 200 when the second application player is used this time.

S2204. Displaying the playing parameter configuration menu, where playing parameters in the playing parameter configuration menu are the playing parameters currently corresponding to the second virtual channel.

The display apparatus 200 generates the playing parameter configuration menu based on the playing parameters obtained in S2203, and reference may be made to the playing parameter configuration menus corresponding to different virtual channels shown in FIG. 14, FIG. 15, FIG. 19, and FIG. 20.

S2103. Receiving a parameter adjustment instruction from the user, where the parameter adjustment instruction indicates adjusted playing parameters.

The user can quickly and accurately learn the playing parameters currently used by the display apparatus 200 based on the playing parameter configuration menu. The user can make adjustments according to the current values of each parameter option in the playing parameter configuration menu to obtain the adjusted playing parameters that meet the current playing requirements.

Taking the playing parameter configuration menu shown in FIG. 14 as an example, the picture mode currently used by the display apparatus 200 is the motion enhancement mode, which is mainly aimed at pictures with faster motion speeds, such as pictures corresponding to football matches, to avoid deformation, smearing, blurring, etc. of objects in the pictures through a manner such as frame filling. If the audio and video data currently played by the second application player is curling (having slower motion pictures), the motion enhancement mode is not required. If the motion enhancement mode continues to be used, it may be causes delayed playing due to the picture processing process, such as frame filling, and it can takes up more computing resources of the display apparatus 200, and causing problems such as higher power consumption of the display apparatus 200. At this time, the user can adjust the picture mode. In some embodiments of the disclosure, the user can control the remote controller to move the focus to an option of the picture mode, and selects the adjusted image mode, such as a standard mode, to send the parameter adjustment instruction to the display apparatus 200, to indicate that the adjust picture mode of the display apparatus 200 is standard mode.

S2104. In response to the parameter adjustment instruction, establishing a correspondence between the second virtual channel and the adjusted playing parameters, and playing audio and video data provided by the second application player using the adjusted playing parameters.

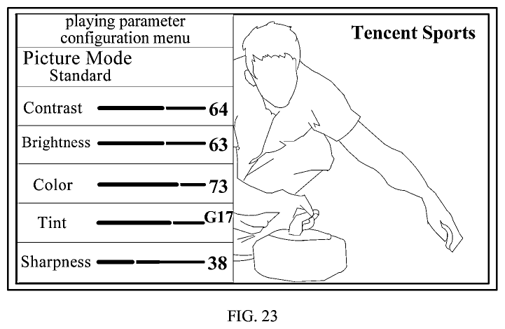

In response to the parameter adjustment instruction, the display apparatus 200 configures the adjusted playing parameters as the playing parameters used currently. As shown in FIG. 23, compared with FIG. 14, the picture mode is adjusted and is adjusted to the standard mode.

The display apparatus 200 establishes a correspondence between the second virtual channel and the adjusted playing parameters, and deletes the correspondence between the second virtual channel and the playing parameters that existed before the adjustment. If the second virtual channel is a virtual channel corresponding to the second application player, or the second virtual channel is a virtual channel corresponding to the second application player (i.e., a single-content application player), the adjustment of the playing parameters configured for the second virtual channel will not affect the playing parameters configured for virtual channels corresponding to other application players, so that the playing parameters of each application player can be adjusted individually. If the second virtual channel is a group of virtual channels corresponding to the second application player (i.e., multi-content application player), the adjustment of the playing parameters configured for one of the group of virtual channels will not affect the playing parameters configured for other virtual channels in the group of virtual channels, nor will it affect the playing parameters configured for virtual channels corresponding to other application players, so that not only is it possible to realize separate adjustment of the playing parameters of each application player, but it is also possible to realize separate adjustment of the playing parameters of different content categories within the same application player.

The display apparatus 200 stores the reconstructed correspondence between the second virtual channel and the adjusted playing parameters, and determines the playing parameters to be used according to the reconstructed correspondence when monitoring the second application player is launched next time.

Therefore, based on the virtual channel configured for each application player and the independent playing parameters configured for each virtual channel, the playing parameters of each application player can be independently adjusted, and the playing parameters of each content category of the same application player can be independently adjusted, so as to achieve the independent management of the playing parameters of each application player.

In addition, when using the display apparatus, users often find that when the display apparatus is currently running a certain application (for example, the display apparatus is running the second application player mentioned above), that is, when the user interface corresponding to the application is displayed on the display, if an instruction for launching the application is received, the application will be repeatedly launched, which will interrupt the normal use of the application by the user, thereby affecting the user's usage experience, and bring a bad usage experience to the user.

In order to avoid the problem of reducing user experience caused by repeatedly launching the application due to user misoperation, in some embodiments of the disclosure, the display apparatus 200 may determine whether to launch the application according to the status of the application after receiving an instruction for launching the application, avoiding that the operation of launching the application is performed in any scenario after receiving the instruction for launching the application, so as to avoid interrupting the normal use of the application by the user, thereby improving the user's experience of using the application.

It should be noted that the application mentioned below may be the first application player and the second application player mentioned above, or may be other application, which are not limited herein. The steps related to application launch described below may be performed before or after the steps described above and are not overly limited herein.

In some embodiments of the disclosure, in order to facilitate users to launch an application more conveniently, multiple methods for quickly launching the application are provided, including launching the application by using a control device, a historical launched application list, and a second application list, etc.

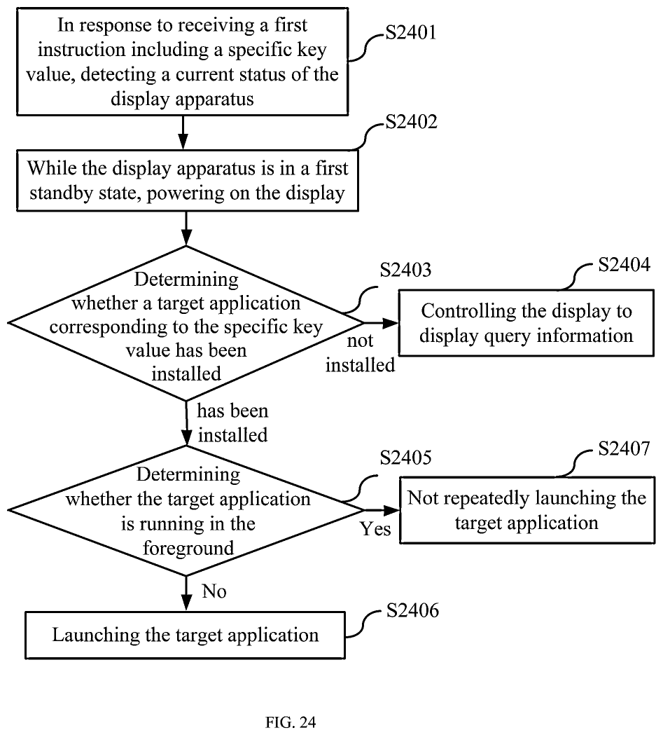

As shown in FIG. 24, the specific steps may include the following.

S2401. In response to receiving a first instruction including a specific key value, detecting a current status of the display apparatus.

In some embodiments of the disclosure, the control device is provided with specific keys, the specific keys have unique specific key values, and each specific key corresponds to an application. When the user presses a specific key on the control device, a first instruction including a specific key value corresponding to the specific key is generated, and the display apparatus executes a method of launching the application in response to the first instruction.

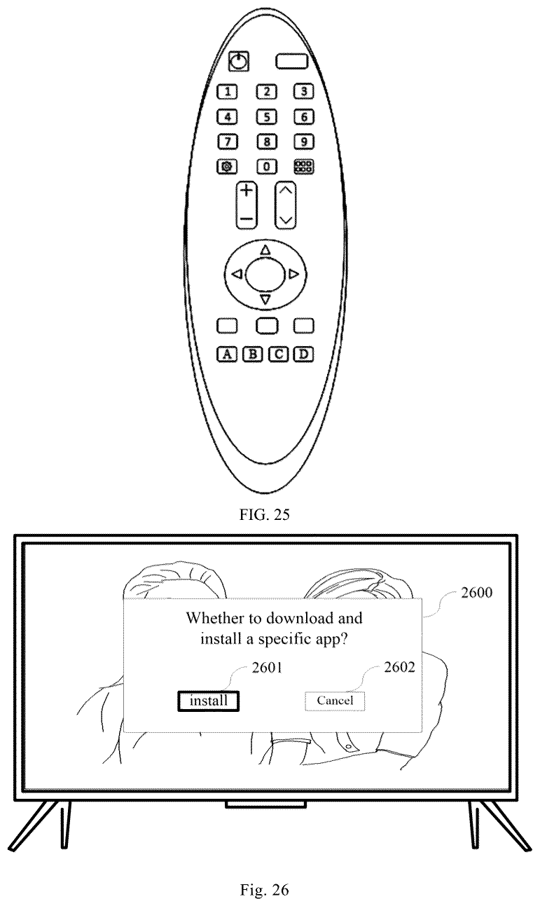

As shown in FIG. 25, FIG. 25 exemplarily shows a schematic diagram of a control device according to some embodiments of the disclosure. In FIG. 25, a plurality of specific keys are provided, including a specific key A corresponding to an application A, a specific key B corresponding to an application B, a specific key C corresponding to an application C, and a specific key D corresponding to an application D.

In some embodiments of the disclosure, the specific keys can be arranged on the upper part of the control device or on the lower part of the control device. In some embodiments of the disclosure, the specific keys in FIG. 25 are arranged on the lower part of the control device. In the embodiments of the disclosure, the position of the specific keys on the control device is not limited.

In some embodiments of the disclosure, the current state of the display apparatus can include a first standby state, a powered-off state, or a powered-on state, etc. The first standby state of the display apparatus may be a Suspend to RAM (STR) standby state, including the display being on a black screen. The powered-off state can also be called an AC/DC standby state. The powered-off state can include that the display apparatus is only powered on, but the display apparatus is not running any program. The powered-on state of the display apparatus can include the display being displayed normally and the display apparatus running programs normally.

In some embodiments of the disclosure, an operation corresponding to the first instruction is performed according to the current state.

S2402. While the display apparatus is in a first standby state, performing the operation corresponding to the first instruction includes: powering on the display. In some embodiments of the disclosure, when the first instruction is received and the display apparatus is in the first standby state, the display is first powered on, so that the display can normally display the user interface.

In some embodiments of the disclosure, the user presses a specific key on the control device to generate the first instruction. The display apparatus receives the first instruction including the specific key value corresponding to the specific key. The driver in the display apparatus is responsible for pulling up the display apparatus, lighting up the display (i.e. powering on the display), and recording the specific key value. After lighting up the display, the system sends a screen-on broadcast. An application launching service is set up in the display apparatus, and the application launching service reads and records the specific key value after receiving the screen-on broadcast. The application launching service parses the specific key value and determines a target application corresponding to the specific key value that needs to be launched.

In some embodiments of the disclosure, after the display is powered on, executing S2403: determining whether a target application corresponding to the specific key value has been installed. In some embodiments of the disclosure, the application launching service is used to determine whether the target application corresponding to the specific key value has been installed.

In some embodiments of the disclosure, the specific key corresponds to a unique key value (specific key value), and there is a one-to-one correspondence between the specific keys and the applications. In some embodiments of the disclosure, the first instruction including the specific key value is used to instruct the display apparatus to launch a target application corresponding to the specific key value. However, due to different current states of the display apparatuses, the methods for launching the application in response to the first instruction are all different.

When the display apparatus is in the first standby state, the first instruction is received, and the display apparatus controls the display to be powered on. In order to avoid the situation that the target application is not installed and the user interface corresponding to the target application is not displayed on the display apparatus, in some embodiments of the disclosure, after receiving the first instruction and powering on the display, it is determined whether the target application corresponding to the specific key value has been installed. In this way, when the target application is not installed, some embodiments of the disclosure will also perform corresponding operations (described in detail below), so that the user can understand the current situation of the display apparatus, to avoid the problem that the user interface of the target application is not displayed on the display, which causes the user to be puzzled about it, and affects the user's usage experience.

In some embodiments of the disclosure, based on that the target application is not installed, executing S2404: controlling the display to display query information, where the query information includes an installation control. As shown in FIG. 26, FIG. 26 exemplarily shows a schematic diagram of a user interface according to some embodiments. In FIG. 26, query information 2600 is displayed, and the query information includes an installation control 2601 and a cancellation control 2602.

In response to receiving a second instruction for selecting the installation control, the target application is downloaded and installed. In some embodiments of the disclosure, the user can move the focus to the installation control through the control device and press the confirm key on the control device, to generate the second instruction for selecting the installation control.

It should be noted that in some embodiments of the disclosure, when the focus is moved to a control, the border of the control can be thickened. In addition, other forms can also be used to indicate that the control is selected. For example, when the focus is moved to the control, a shape of the control can change, e.g., the control may be changed from a square to a circle, etc., or when the control is selected, the control can be enlarged according to a preset ratio. For example, display areas of controls on the user interface are the same, and when a certain control is selected, the display area of the control is increased by 1.2 times compared with the original display area of the control. Since this disclosure does not limit the shape of the control when the focus is on the control, other forms that can facilitate the user to distinguish the selected control are acceptable.

In some embodiments of the disclosure, when the display apparatus receives the second instruction, the third-party software is used to install the application, and the target application is downloaded and installed. In some embodiments of the disclosure, when the second instruction is received, an installation interface is displayed by the display, and the current installation progress of the target application is displayed on the installation interface. In some embodiments, the installation progress may be displayed using a progress bar. As shown in FIG. 27, FIG. 27 exemplarily shows another schematic diagram of a user interface according to some embodiments. A progress bar 2701 is shown in FIG. 27, for indicating that the installation progress of the target application is 80% at this time.

In some embodiments of the disclosure, a stop installation control may also be displayed on the installation interface, and a seventh instruction for selecting the stop installation control is received to control the display apparatus to stop installing the target application. Referring again to FIG. 27, a stop installation control 2702 is also shown in FIG. 27.

In some embodiments of the disclosure, in response to receiving a sixth instruction for selecting the cancel control, the display is controlled to cancel the display of the query information. In some embodiments of the disclosure, the user uses the control device to move the focus to the cancel control and presses the confirm key on the control device to generate the sixth instruction. Referring again to FIG. 26, in FIG. 26, the user uses the control device to move the focus to the cancel control 2602, and presses the confirm key on the control device, so that the query information is canceled at this time.

In some embodiments of the disclosure, if the target application is not installed, the application search interface or application details page provided by the third-party application is directly displayed on the display to allow the user to choose whether to install the target application.

In some embodiments of the disclosure, when the target application is not installed, the display can be controlled to display an application search interface, and a search box is displayed on the application search interface. The user can enter a name of an application into the search box and press the confirm key. As such, an application installation interface corresponding to the name of the application is displayed according to the name of the application. In some embodiments, application categories are displayed on the application search interface, and a corresponding application is provided under each application category. The user can use the control device to move the focus to an application category control and press the confirm key on the control device, and then the user interface displays the application under the application category. The user can continue to use the control device to move the focus to a certain application control and press the confirm key on the control device, at which time the user interface jumps to the application installation interface corresponding to the application.

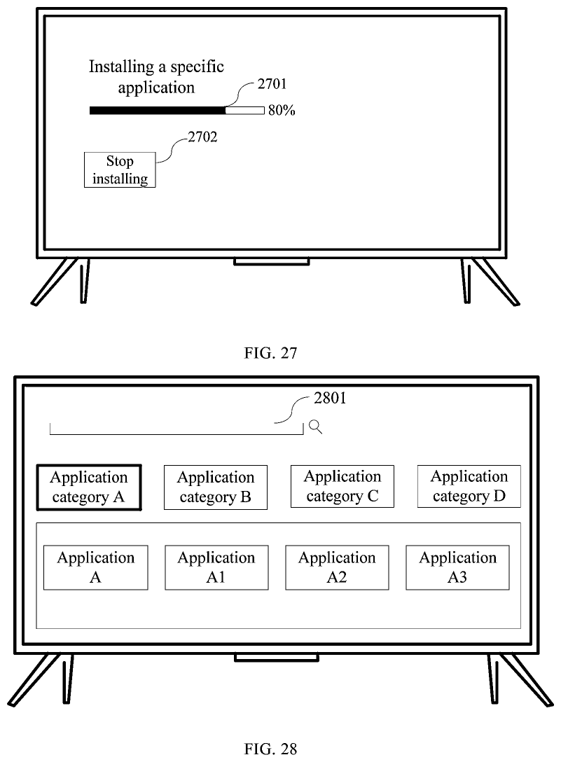

In some embodiments of the disclosure, the application installation interface displays a first confirm installation control and a first cancel installation control. After receiving an instruction for selecting the first confirm installation control, the target application is downloaded and installed. After receiving an instruction for selecting the first cancel installation control, the display of the application search interface is canceled. As shown in FIG. 28, FIG. 28 exemplarily shows yet another schematic diagram of a user interface according to some embodiments of the disclosure. A search box 2801 is shown in FIG. 28, and the user can enter a name of the application for which the user wants to download in the search box 2801 and press the confirm key. In addition, the user can move the focus to a control of application category A and press the confirm key on the control device, and then an application control of the application corresponding to the application category A is displayed on the user interface. The user can move the focus to an application control corresponding to an application that the user wishes to install, and press the confirm key on the control device, and then the application installation interface is displayed.

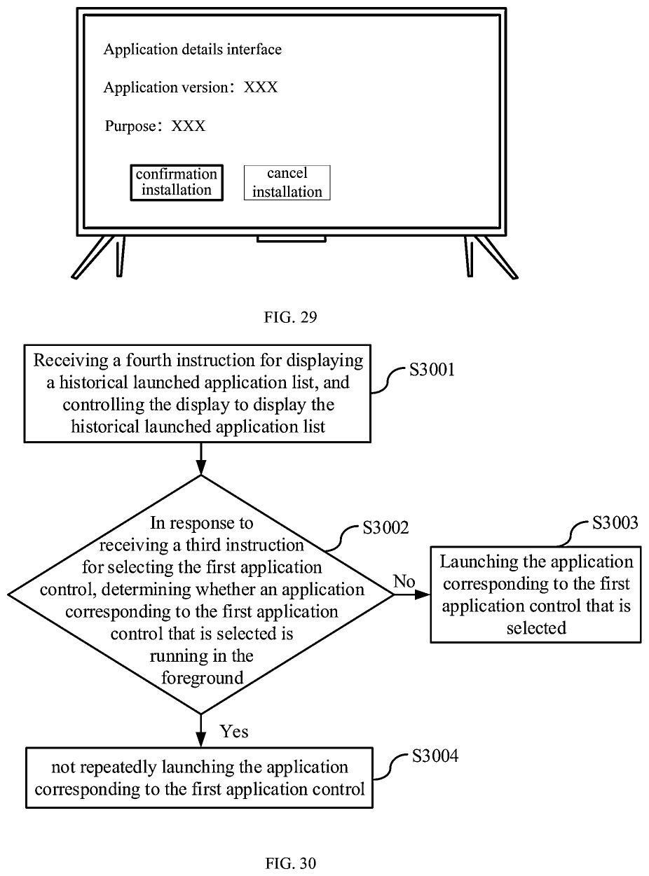

In some embodiments of the disclosure, when the target application is not installed, the display can be controlled to display an application details interface. The application details interface displays relevant information of the target application, such as the version and purpose of the target application. The application details interface also displays a second confirm installation control and a second cancel installation control. After receiving an instruction for selecting the second confirmation installation control, the target application is downloaded and installed. After receiving an instruction for selecting the second cancel installation control, the display of the application details interface is cancelled. In some embodiments of the disclosure, as shown in FIG. 29, FIG. 29 exemplarily shows yet another schematic diagram of a user interface according to some embodiments.

S2405. Based on that the target application has been installed, determining whether the target application is running in the foreground. In some embodiments of the disclosure, in order to avoid repeatedly launching the target application and interrupting the normal use of the target application by the user, it can be understood that when the display apparatus is playing a video using the application, if the application is repeatedly launched, the video playing will be interrupted. Therefore, before launching the target application, whether the target application is running in the foreground is determined.

In some embodiments of the disclosure, the step of determining whether the target application is running in the foreground includes:
obtaining a first application list in the display apparatus, where the first application list includes at least one first application that has been launched in the display apparatus. In some embodiments of the disclosure, the first application in the first application list includes an application that has been launched on the display apparatus. The first applications in the first application list are arranged in reverse order of use. In some embodiments of the disclosure, application A, application B, and application C are used sequentially on the display apparatus, and stored as application C, application B, and application A in the first application list in reverse order of use.

In some embodiments of the disclosure, the first application list is obtained through an activity management service (ActivityManager).

Determining whether a first application at a top of the first application list is the same as the target application. It should be understood that an application last used on the display apparatus is the application running in the foreground. For example, when application A, application B and application C are used sequentially on the display apparatus, the application running in the foreground at this time is the application C. Therefore, in some embodiments of the disclosure, the first application that is located at the top of the first application list, i.e., the application in the foreground, is obtained.

Based on that the first application is the same as the target application, it is determined that the target application is running in the foreground; based on that the first application is different from the target application, it is determined that the target application is not running in the foreground. In some embodiments of the disclosure, if the first application at the top of the first application list is the same as the target application, it means that the target application is running in the foreground. If the first application at the top of the first application list is different from the target application, it means that the target application is not running in the foreground.

S2406. Based on that the target application is not running in the foreground, launching the target application. In some embodiments of the disclosure, if the target application is not running in the foreground, the target application is launched, so that it is running in the foreground, and the user can use the application on the display apparatus.

S2407. Based on that the target application is running in the foreground, not repeatedly launching the target application. In the embodiment of the disclosure, if the target application is already running in the foreground, in order to avoid repeatedly launching the target application and interrupting the normal use of the target application by the user, the operation of launching the target application is not performed.

In some embodiments of the disclosure, while the display apparatus is in the powered-on state and receives a first instruction including a specific key value, it is determined whether the target application corresponding to the specific key value has been installed.

In some embodiments of the disclosure, the user presses a specific key on the control device to generate the first instruction including the specific key value. The driver of the display apparatus transfers the specific key value to the application launching service, and the application launching service parses the specific key value and determines the target application corresponding to the specific key value needs to be launched.

In some embodiments of the disclosure, while the display apparatus is in the powered-on state, the user presses the specific key on the control device to launch the target application corresponding to the specific key. However, if the target application is not installed on the display apparatus, the display apparatus may not response to the first instruction, thus affecting the usage experience of user. Therefore, in the embodiments of the disclosure, while the display apparatus is in the powered-on state and receives the first instruction including the specific key value, it is necessary to determine whether the target application corresponding to the specific key value has been installed.

Based on that the target application has not been installed, the display is controlled to display query information, where the query information includes an installation control; in response to receiving a second instruction for selecting the installation control, the target application is downloaded and installed.

Based on that the target application has been installed, determining whether the target application is running in the foreground; based on that the target application is not running in the foreground, the target application is launched; based on that the target application is running in the foreground, the target application is not launched repeatedly.

In some embodiments of the disclosure, except that the display needs to be powered on in the first standby state, the steps of receiving the first instruction when the display apparatus is in the powered-on state is the same as the rest of the steps of receiving the first instruction when the display apparatus is in the first standby state, and will not be described in detail herein.

In some embodiments of the disclosure, while the current state is a powered-off state, performing the operation corresponding to the first instruction includes: starting a power on process, i.e., controlling the display apparatus to be powered on. In some embodiments of the disclosure, when the display apparatus is in the powered-off state, the user presses a specific key on the control device to input a first instruction. The first instruction can cause the display apparatus in the powered-off state to be powered on, and then the target application corresponding to a specific key value can be continued to be launched after the display apparatus is powered on.

In some embodiments of the disclosure, while the display apparatus is in the powered-off state, the first instruction including the specific key value is received, the driver of the display apparatus pulls up the display apparatus, lights the display, and records the specific key value. After pulling up the display apparatus, the system sends an unlock broadcast and reads an underlying boot reason from the driver. In some embodiments of the disclosure, the boot reason is that the first instruction including the specific key value is received and a broadcast with the specific key value is sent, and after the application launching service receives the broadcast with the specific key value, it parses the specific key value and determines that the target application corresponding to the specific key value needs to be launched.

In order to avoid that the display apparatus cannot display the user interface of the target application after receiving the first instruction due to the target application is no installed on the display apparatus, which may bring a bad usage experience to the user, in some embodiments of the disclosure, after the display apparatus is powered on, it is determined whether the target application corresponding to the specific key value has been installed.

Based on that the target application has been installed, the target application is launched. In some embodiments of the disclosure, when the target application has been installed, the target application is directly launched. Based on that the target application is not installed, the display is controlled to display query information, and the query information includes the installation control; in response to receiving the second instruction for selecting the installation control, the target application is downloaded and installed. In some embodiments of the disclosure, the process of downloading and installing the target application has been described in detail above and will not be repeated herein.

In other embodiments of the disclosure, as shown in FIG. 30, the above method may include the following steps.

S3001. Receiving a fourth instruction for displaying a historical launched application list, and controlling the display to display the historical launched application list. The historical launched application list includes at least one first application control corresponding to an application that has been used before receiving the fourth instruction. In some embodiments of the disclosure, the user can press a key on the control device associated with the historical launched application list to input the fourth instruction. For example, the user can long press the home key, or press a corresponding key for displaying the history launched application list on the control device. In some embodiments of the disclosure, the display is controlled to display the historical launched application list by selecting an entry control configured on the user interface for displaying the historical launched application list.

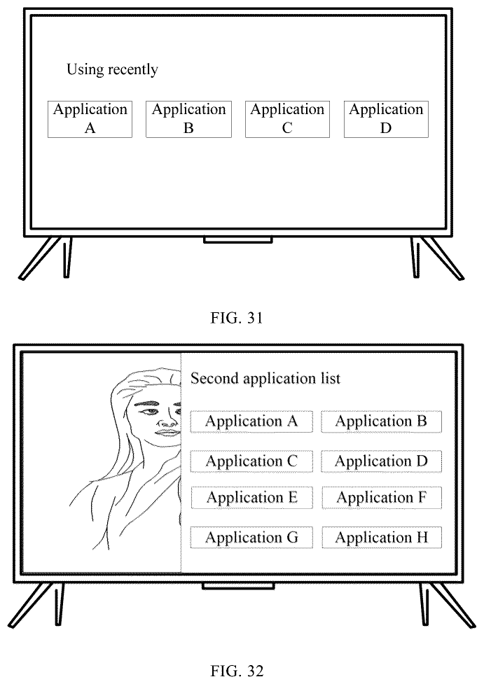

In some embodiments of the disclosure, the applications in the historical launched application list are arranged in order of use, with the first application control corresponding to the last used application being arranged first. In some embodiments of the disclosure, the applications in the historical launched application list are applications used within a preset time period. In some embodiments of the disclosure, the historical launched application list can include applications that have been used in the past three days. As shown in FIG. 31, FIG. 31 exemplarily shows a schematic diagram of a historical launched application list provided according to some embodiments.

S3002. In response to receiving a third instruction for selecting the first application control, determining whether an application corresponding to the first application control that is selected is running in the foreground.

In some embodiments of the disclosure, the user can move the focus to the first application control in the historical launched application list through the control device and press the confirm key on the control device. At this time, it is determined that the user has input the third instruction.

In the embodiments of the disclosure, for the normal use of the application by the user, after receiving the third instruction, it is determined whether the application corresponding to the first application control that is selected is running in the foreground.

S3003. Based on that the application corresponding to the first application control is not running in the foreground, launching the application corresponding to the first application control that is selected.

S3004. Based on that the application corresponding to the first application control is running in the foreground, not repeatedly launching the application corresponding to the first application control.

In some embodiments of the disclosure, when an application in the display apparatus is uninstalled, the information corresponding to the uninstalled application in the historical launched application list is deleted at the same time. In some embodiments of the disclosure, the user uses application A on the display apparatus and uninstalls application A after use, so that the content corresponding to application A does not exist in the historical launched application list displayed when the fourth instruction is received. In some embodiments of the disclosure, the step of determining whether the application corresponding to the first application control that is selected is running in the foreground includes:
obtaining the first application list in the display apparatus, determining whether a first application which is ranked second in the first application list is the same as the application corresponding to the first application control. In the embodiments of the disclosure, since a historical launched application list is currently displayed on the user interface, it can be understood that the historical launched application list also belongs to a certain application, so the application at the top of the first application list at this time must be the application corresponding to the historical launched application list, thus determining whether the first application which is ranked second in the first application list is the same as the application corresponding to the first application control. Based on that the first application is the same as the application corresponding to the first application control, determining that the application corresponding to the first application control is running in the foreground; based on that the first application is different from the application corresponding to the first application control, determining that the application corresponding to the first application control is not running in the foreground.

Finally, the specific steps for launching an application using the second application list are introduced in detail, which may include:
a fifth instruction for displaying a second application list is received, and the display is controlled to display the second application list, where the second application list includes at least one first application control corresponding to an application installed on the display apparatus. In some embodiments of the disclosure, as shown in FIG. 32, FIG. 32 exemplarily shows yet another schematic diagram of a user interface according to some embodiments of the disclosure, and a second application list is shown in FIG. 32, and the second application list can include a plurality of first application controls.

In some embodiments of the disclosure, the user may press a key associated with the second application list on the control device to generate the fifth instruction. In some embodiments of the disclosure, the display can also be controlled to display the second application list by selecting an entry control configured on the user interface for displaying the second application list.

In response to receiving the third instruction for selecting the first application control, it is determined whether the application corresponding to the first application control that is selected is running in the foreground; based on that the application corresponding to the first application control is not running in the foreground, the application corresponding to the first application control that is selected is launched; based on that the application corresponding to the first application control is running in the foreground, the application corresponding to the first application control is not repeatedly launched.

In some embodiments of the disclosure, methods of launching an application using a specific key, a historical launched application list, and a second application list are provided. In the methods, the launching process of applications in different states, the launching process of applications that are installed but not running in the foreground or are already running in the foreground, and the launching process of the applications that are not installed are described in detail, and the interactive experience of the user is improved by segmenting the operation of application launching in different states.

For the convenience of explanation, the above descriptions have been made in combination with specific embodiments. However, the above discussions of some embodiments are not intended to be exhaustive or to limit implementations to the specific forms disclosed above. Numerous modifications and variations can be obtained in light of the above teachings. The above embodiments are chosen and described in order to better explain the contents of the disclosure, to enable those skilled in the art to better utilize the described embodiments.

What is claimed is:

1. A display apparatus, comprising:
a display, configured to display an image from broadcast system or network and/or a user interface;
a communicating device, configured to connect with the network and a control device; and
a user port, configured to receive an input signal;
at least one processor connected with the display and the user port, wherein the at least one processor is configured to execute instructions to cause the display apparatus to:
detect a current state of the display apparatus in response to receiving a first instruction comprising a specific key value;
perform an operation corresponding to the first instruction according to the current state;
wherein while the display apparatus is in a first standby state, the at least one processor is further configured to execute instructions to cause the display apparatus to:
power on the display;
determine whether a target application corresponding to the specific key value has been installed;
based on that the target application has not been installed, control the display to display query information, wherein the query information comprises an installation control; and in response to receiving a second instruction for selecting the installation control, download and install the target application;
based on that the target application has been installed, determine whether the target application is running in foreground, and based on that the target application is not running in the foreground, launch the target application.

2. The display apparatus according to claim 1, wherein the at least one processor is further configured to execute instructions to cause the display apparatus to:
obtain a first application list in the display apparatus, wherein the first application list comprises at least one first application that has been launched in the display apparatus, and first applications in the first application list are arranged in reverse order of use;
determine whether a first application at a top of the first application list is the same as the target application;
based on that the first application is the same as the target application, determine that the target application is running in the foreground;
based on that the first application is different from the target application, determine that the target application is not running in the foreground.

3. The display apparatus according to claim 1, wherein the at least one processor is further configured to execute instructions to cause the display apparatus to:
while the display apparatus is in a powered-on state, determine whether the target application corresponding to the specific key value has been installed;
based on that the target application has not been installed, control the display to display query information, wherein the query information comprises the installation control, and in response to receiving the second instruction for selecting the installation control, download and install the target application;
based on that the target application has been installed, determine whether the target application is running in the foreground, and based on that the target application is not running in the foreground, launch the target application.

4. The display apparatus according to claim 1, wherein the at least one processor is further configured to execute instructions to cause the display apparatus to:
while the current state is a powered-off state, start a power on process;
determine whether the target application corresponding to the specific key value has been installed;
based on that the target application has been installed, launch the target application;
based on that the target application has not been installed, control the display to display query information, wherein the query information comprises the installation control; and in response to receiving the second instruction for selecting the installation control, download and install the target application.

5. The display apparatus according to claim 1, wherein the at least one processor is further configured to execute instructions to cause the display apparatus to:
in response to receiving a third instruction for selecting a first application control, determine whether an application corresponding to the first application control that is selected is running in foreground;
based on that the application corresponding to the first application control is not running in the foreground, launch the application corresponding to the first application control that is selected;
based on that the application corresponding to the first application control is running in the foreground, not repeatedly launch the application corresponding to the first application control.

6. The display apparatus according to claim 5, wherein the at least one processor is further configured to execute instructions to cause the display apparatus to:
before receiving the third instruction for selecting the first application control, receive a fourth instruction for displaying a historical launched application list; and
control the display to display the historical launched application list,
wherein the historical launched application list comprises at least one first application control corresponding to an application that has been used before receiving the fourth instruction.

7. The display apparatus according to claim 5, wherein the at least one processor is further configured to execute instructions to cause the display apparatus to:
before receiving the third instruction for selecting the first application control, receive a fifth instruction for displaying a second application list; and
control the display to display the second application list;
wherein the second application list comprises at least one first application control corresponding to an application installed on the display apparatus.

8. The display apparatus according to claim 5, wherein the at least one processor is further configured to execute instructions to cause the display apparatus to:
obtain a first application list in the display apparatus, wherein the first application list comprises at least one first application that has been launched in the display apparatus, and first applications in the first application list are arranged in reverse order of use;
determine whether a first application which is ranked second in the first application list is the same as the application corresponding to the first application control;
based on that the first application is the same as the application corresponding to the first application control, determine that the application corresponding to the first application control is running in the foreground;
based on that the first application is different from the application corresponding to the first application control, determine that the application corresponding to the first application control is not running in the foreground.

9. The display apparatus according to claim 1, wherein
when the target application is configured to play audio and video data, one application player corresponds to at least one virtual channel;
for the target application corresponds to one virtual channel, playing parameters configured for the one virtual channel correspond to all categories of audio and video data provided by the target application, wherein the categories refer to content categories of the audio and video data;
for the target application corresponds to multiple virtual channels, playing parameters configured for each of the multiple virtual channels correspond to one category of audio and video data provided by the target application, wherein playing parameters configured for different virtual channels correspond to different categories of audio and video data.

10. A processing method for a display apparatus, comprising:
detecting a current state of the display apparatus in response to receiving a first instruction comprising a specific key value; and
performing an operation corresponding to the first instruction according to the current state;
wherein while the current state is a first standby state, the performing the operation corresponding to the first instruction comprises:
powering on a display of the display apparatus;
determining whether a target application corresponding to the specific key value has been installed;
based on that the target application has not been installed, controlling the display to display query information, wherein the query information comprises an installation control; and in response to receiving a second instruction for selecting the installation control, downloading and installing the target application;
based on that the target application has been installed, determine whether the target application is running in foreground, and based on that the target application is not running in the foreground, launching the target application.

11. The method according to claim 10, wherein the determining whether the target application is running in the foreground comprises:
obtaining a first application list in the display apparatus, wherein the first application list comprises at least one first application that has been launched in the display apparatus, and first applications in the first application list are arranged in reverse order of use;
determining whether a first application at a top of the first application list is the same as the target application;
based on that the first application is the same as the target application, determining that the target application is running in the foreground;
based on that the first application is different from the target application, determining that the target application is not running in the foreground.

12. The method according to claim 10, wherein while the display apparatus is in a powered-on state, the performing the operation corresponding to the first instruction comprises:
determining whether the target application corresponding to the specific key value has been installed;
based on that the target application has not been installed, controlling the display to display the query information, wherein the query information comprises the installation control; in response to receiving the second instruction for selecting the installation control, downloading and installing the target application;
based on that the target application has been installed, determining whether the target application is running in the foreground; and based on that the target application is not running in the foreground, launching the target application.

13. The method according to claim 10, wherein while the current state is a powered-off state, the performing the operation corresponding to the first instruction comprises:
starting a power on process;
determining whether the target application corresponding to the specific key value has been installed;
based on that the target application has been installed, launching the target application;
based on that the target application has not been installed, controlling the display to display query information, wherein the query information comprises an installation control; and
in response to receiving the second instruction for selecting the installation control, downloading and installing the target application.

14. The method according to claim 10, further comprising:
in response to receiving a third instruction for selecting a first application control, determining whether an application corresponding to the first application control that is selected is running in foreground;
based on that the application corresponding to the first application control is not running in the foreground, launching the application corresponding to the first application control that is selected;
based on that the application corresponding to the first application control is running in the foreground, not repeatedly launching the application corresponding to the first application control.

15. The method according to claim 14, wherein before receiving the third instruction for selecting the first application control, the method further comprises:
receiving a fourth instruction for displaying a historical launched application list, and
controlling the display to display the historical launched application list;
wherein the historical launched application list comprises at least one first application control corresponding to an application that has been used before receiving the fourth instruction.

16. The method according to claim 14, wherein before receiving the third instruction for selecting the first application control, the method further comprises:
receiving a fifth instruction for displaying a second application list, and
controlling the display to display the second application list;
wherein the second application list comprises at least one first application control corresponding to an application installed on the display apparatus.

17. The method according to claim 14, the determining whether the application corresponding to the first application control that is selected is running in the foreground comprises:
obtaining a first application list in the display apparatus, wherein the first application list comprises at least one first application that has been launched in the display apparatus, and first applications in the first application list are arranged in reverse order of use;
determining whether a first application which is ranked second in the first application list is the same as the application corresponding to the first application control;
based on that the first application is the same as the application corresponding to the first application control, determining that the application corresponding to the first application control is running in the foreground;
based on that the first application is different from the application corresponding to the first application control, determining that the application corresponding to the first application control is not running in the foreground.

18. The method according to claim 10, wherein when the target application is configured to play audio and video data, one application player corresponds to at least one virtual channel;
for the target application corresponds to one virtual channel, playing parameters configured for the one virtual channel correspond to all categories of audio and video data provided by the target application, wherein the categories refer to content categories of the audio and video data;
for the target application corresponds to multiple virtual channels, playing parameters configured for each of the multiple virtual channels correspond to one category of audio and video data provided by the target application, wherein playing parameters configured for different virtual channels correspond to different categories of audio and video data.
